(19) United States
(12) Patent Application Publication
(10) Pub. No.: US 2025/0158320 A1
(43) Pub. Date: May 15, 2025

(54) CONNECTOR UNIT

(71) Applicant: Japan Aviation Electronics Industry, Ltd., Tokyo (JP)

(72) Inventors: Masakazu MATSUMOTO, Tokyo (JP); Tetsu URANO, Tokyo (JP)

(21) Appl. No.: 18/945,777

(22) Filed: Nov. 13, 2024

(30) Foreign Application Priority Data
Nov. 15, 2023 (JP) 2023-194506
Jul. 4, 2024 (JP) 2024-107832

(51) Int. Cl. H01R 13/52; H01R 13/405

(52) U.S. Cl. CPC H01R 13/521; H01R 13/405

(57) ABSTRACT

Provided is a connector unit capable of achieving an airtight structure around a pin terminal and a socket terminal with a small number of parts. The connector unit includes a socket connector including a socket terminal and a socket-side holding member covering an outer peripheral surface of the socket terminal in an airtight manner, and a pin connector including a pin terminal and a pin-side holding member covering an outer peripheral surface of the pin terminal in an airtight manner. The socket-side holding member includes a recessed part into which the pin-side holding member is to be inserted. An end face of the socket terminal comes into contact with the pin-side holding member, and the pin-side holding member comes into contact with a bottom face of the recessed part of the socket-side holding member.

### INCORPORATION BY REFERENCE

This application is based upon and claims the benefit of priority from Japanese patent application No. 2023-194506, filed on Nov. 15, 2023, and Japanese patent application No. 2024-107832, filed on Jul. 4, 2024, the disclosure of which is incorporated herein in its entirety by reference.

### BACKGROUND

The present disclosure relates to a connector unit.

In general, a connector unit preferably has a structure capable of controlling partial discharge (corona discharge) in a connection state of a pin connector and a socket connector. For example, as shown in FIG. 27, a connector unit 100 according to Patent Literature 1 (Japanese Utility Model Registration Publication No. 2517429) includes a pin connector 103 where a pin terminal 102 is formed by insert molding on a base 101 and a socket connector 106 where a socket terminal 105 is formed by insert molding on a base 104.

A bottomed cylindrical part 101a of the base 101 is covered with a seal packing 107 made of flexible synthetic resin, and in the state where the bottomed cylindrical part 101a of the base 101 mates with a holding cylinder 104a of the base 104, an end of the socket terminal 105 on the pin connector 103 side comes into contact with the seal packing 107, and an end of the holding cylinder 104a of the base 104 on the pin connector 103 side comes into contact with the seal packing 107.

In this structure, an outer peripheral surface of the pin terminal 102 is covered in an airtight manner with the base 101, and the outer peripheral surface of the socket terminal 105 is covered in an airtight manner with the base 104. At the same time, in the state where the bottomed cylindrical part 101a of the base 101 mates with the holding cylinder 104a of the base 104, an end of the socket terminal 105 on the pin connector 103 side comes into contact with the seal packing 107, and an end of the holding cylinder 104a of the base 104 on the pin connector 103 side comes into contact with the seal packing 107.

In this manner, in the connector unit 100 according to Patent Literature 1, areas around the pin terminal 102 and the socket terminal 105 have an airtight structure in the connection state of the pin connector 103 and the socket connector 106, thereby controlling partial discharge.
Patent Literature 1: Japanese Utility Model Registration Publication No. 2517429

### SUMMARY

The connector unit 100 according to Patent Literature 1 needs the seal packing 107 in addition to the base 101 of the pin connector 103 and the base 104 of the socket connector 106 in order to achieve an airtight structure around the pin terminal 102 and the socket terminal 105 in the connection state of the pin connector 103 and the socket connector 106.

Thus, the connector unit 100 according to Patent Literature 1 has a problem that the number of parts is large to achieve an airtight structure around the pin terminal 102 and the socket terminal 105 in the connection state of the pin connector 103 and the socket connector 106.

An object of the present disclosure is to provide a connector unit capable of achieving an airtight structure around a pin terminal and a socket terminal in a connection state of a pin connector and a socket connector with a small number of parts.

A connector unit according to one aspect of the present disclosure includes a socket connector including a socket terminal and a socket-side holding member configured to cover an outer peripheral surface of the socket terminal in an airtight manner; and a pin connector including a pin terminal to be connected to the socket terminal and a pin-side holding member configured to cover an outer peripheral surface of the pin terminal in an airtight manner, wherein the socket-side holding member includes a recessed part formed to surround an end face of the socket terminal on a connection side with the pin connector and where an end of the pin-side holding member on a connection side with the socket connector is to be inserted in a state where the socket connector and the pin connector are connected, the pin-side holding member is made of an elastic material, and inside the recessed part of the socket-side holding member in the state where the socket connector and the pin connector are connected, the end face of the socket terminal on the connection side with the pin connector comes into contact with the pin-side holding member, and the end of the pin-side holding member on the connection side with the socket connector comes into contact with a bottom face of the recessed part of the socket-side holding member.

A connector unit according to one aspect of the present disclosure includes a socket connector including a socket terminal and a socket-side holding member configured to cover an outer peripheral surface of the socket terminal in an airtight manner; and a pin connector including a pin terminal to be connected to the socket terminal, a first pin-side holding member configured to cover an outer peripheral surface of the pin terminal in an airtight manner, and a biasing member configured to exert a force on the first pin-side holding member toward a connection side with the socket connector when the first pin-side holding member is pushed to a side opposite to the connection side with the socket connector, wherein the socket-side holding member includes a recessed part formed to surround an end face of the socket terminal on a connection side with the pin connector and where an end of the first pin-side holding member on the connection side with the socket connector is to be inserted in a state where the socket connector and the pin connector are connected, the first pin-side holding member is made of an elastic material, inside the recessed part of the socket-side holding member in the state where the socket connector and the pin connector are connected, the end face of the socket terminal on the connection side with the pin connector comes into contact with the first pin-side holding member, and the end of the first pin-side holding member on the connection side with the socket connector comes into contact with a bottom face of the recessed part of the socket-side holding member, the first pin-side holding member includes a flange part to be pushed by the biasing member and an extension part extending to the side opposite to the connection side with the socket connector relative to the flange part, and the biasing member includes a plurality of divided pieces and is disposed to surround the extension part of the first pin-side holding member.

According to the present disclosure, a connector unit capable of achieving an airtight structure around a pin terminal and a socket terminal in the connection state of a pin connector and a socket connector with a small number of parts is provided.

The above and other objects, features and advantages of the present disclosure will become more fully understood from the detailed description given hereinbelow and the accompanying drawings.

### BRIEF DESCRIPTION OF DRAWINGS

FIG. 1 is a perspective view from the negative side of the y-axis showing the state where a socket connector and a pin connector are connected in a connector unit according to a first embodiment;

FIG. 2 is a cross-sectional view showing the state where the socket connector and the pin connector are connected in the connector unit according to the first embodiment;

FIG. 3 is a perspective view from the positive side of the y-axis showing the state where the socket connector and the pin connector are not connected in the connector unit according to the first embodiment;

FIG. 4 is a transparent perspective view from the positive side of the y-axis showing the socket connector in the connector unit according to the first embodiment;

FIG. 5 is a perspective view from the negative side of the y-axis showing the socket connector in the connector unit according to the first embodiment;

FIG. 6 is a cross-sectional view of the socket connector in the connector unit according to the first embodiment;

FIG. 7 is a perspective view from the positive side of the y-axis showing a socket terminal of the socket connector in the connector unit according to the first embodiment;

FIG. 8 is a perspective view from the negative side of the y-axis showing the pin connector in the connector unit according to the first embodiment;

FIG. 9 is an exploded view from the positive side of the y-axis showing the pin connector in the connector unit according to the first embodiment;

FIG. 10 is a cross-sectional view of the pin connector in the connector unit according to the first embodiment;

FIG. 11 is a perspective view from the negative side of the y-axis showing the state where a pin terminal of the pin connector in the connector unit according to the first embodiment is connected to a second wire;

FIG. 12 is a perspective view showing the state where a holding member of the pin connector is integrated with the pin terminal in the connector unit according to the first embodiment;

FIG. 13 is a perspective view from the negative side of the y-axis showing the state where a socket connector and a pin connector are connected in a connector unit according to a second embodiment;

FIG. 14 is a cross-sectional view showing the state where the socket connector and the pin connector are connected in the connector unit according to the second embodiment;

FIG. 15 is a cross-sectional view showing, in a magnified fashion, the state where the socket connector and the pin connector are connected in the connector unit according to the second embodiment;

FIG. 16 is a perspective view from the negative side of the y-axis showing the state where the socket connector and the pin connector are not connected in the connector unit according to the second embodiment;

FIG. 17 is a perspective view from the positive side of the y-axis showing the socket connector in the connector unit according to the second embodiment;

FIG. 18 is a view from the positive side of the x-axis showing the socket connector in the connector unit according to the second embodiment;

FIG. 19 is a view from the positive side of the y-axis showing the socket connector in the connector unit according to the second embodiment;

FIG. 20 is a cross-sectional view of the socket connector in the connector unit according to the second embodiment;

FIG. 21 is a perspective view from the negative side of the y-axis showing the pin connector in the connector unit according to the second embodiment;

FIG. 22 is a view from the positive side of the x-axis showing the pin connector in the connector unit according to the second embodiment;

FIG. 23 is a view from the negative side of the y-axis showing the pin connector in the connector unit according to the second embodiment;

FIG. 24 is a cross-sectional view of the pin connector in the connector unit according to the second embodiment;

FIG. 25 is an exploded perspective view from the negative side of the y-axis showing a pin terminal, a first holding member, a second holding member and the like in the connector unit according to the second embodiment;

FIG. 26 is a view illustrating an engagement structure of the second holding member and a biasing member of the pin connector in the connector unit according to the second embodiment; and

FIG. 27 is a view showing FIG. 1 of Patent Literature 1.

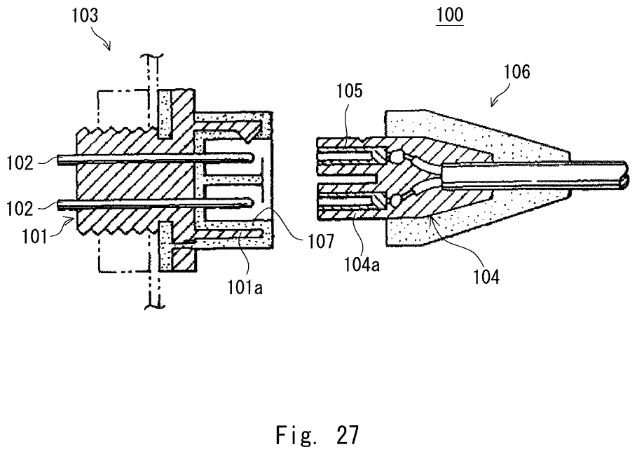

### DESCRIPTION OF EMBODIMENTS

Specific embodiments of the present disclosure will be described hereinafter in detail with reference to the drawings. The present disclosure, however, is not limited to the below-descried embodiments. Further, the following description and the drawings are appropriately shortened and simplified to clarify the explanation. The following description uses a three-dimensional (XYZ) coordinate system to clarify the explanation.

### First Embodiment

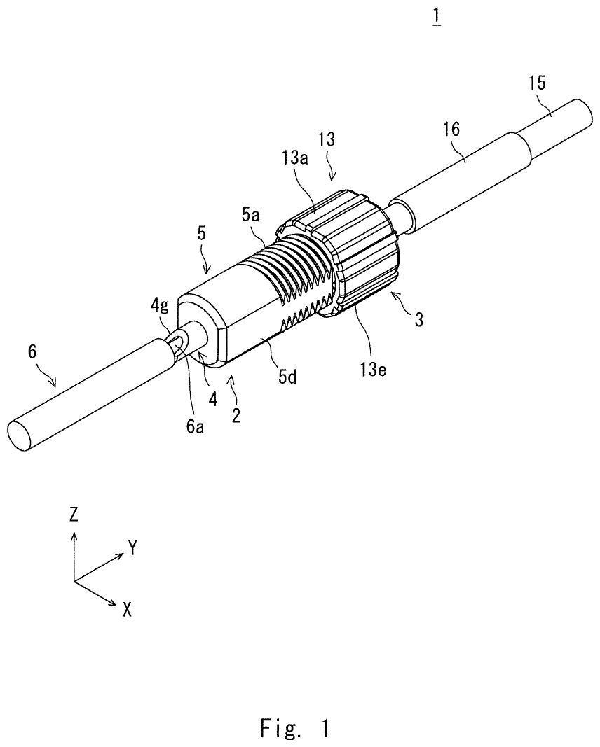

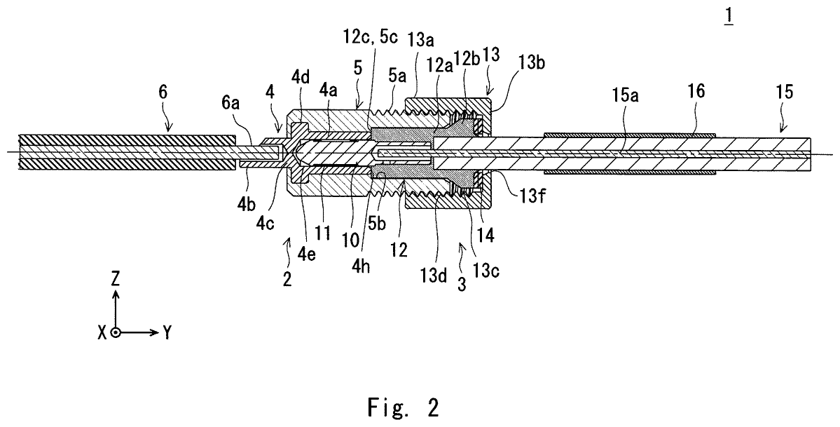

FIG. 1 is a perspective view from the negative side of the y-axis showing the state where a socket connector and a pin connector are connected in a connector unit according to this embodiment. FIG. 2 is a cross-sectional view showing the state where the socket connector and the pin connector are connected in the connector unit according to this embodiment.

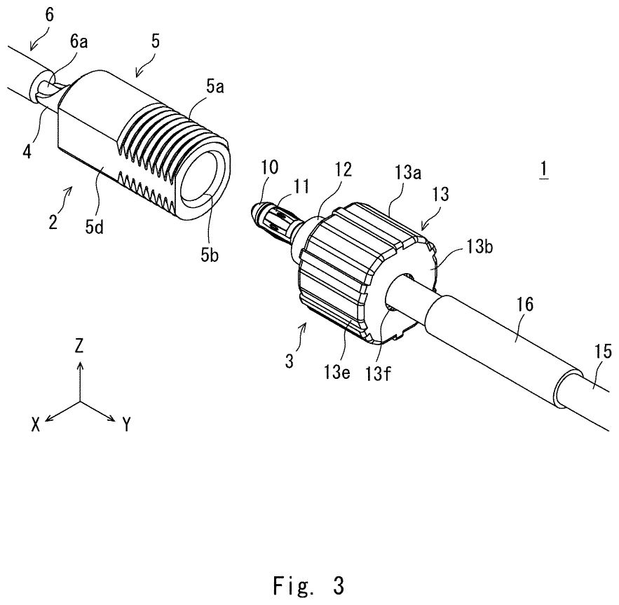

FIG. 3 is a perspective view from the positive side of the y-axis showing the state where the socket connector and the pin connector are not connected in the connector unit according to this embodiment. A connector unit 1 according to this embodiment is a high-voltage connector unit, for example, and it includes a socket connector 2 and a pin connector 3 as shown in FIGS. 1 to 3.

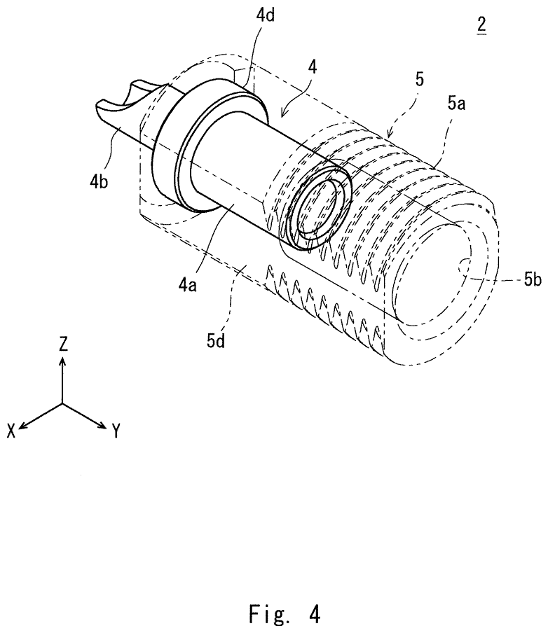

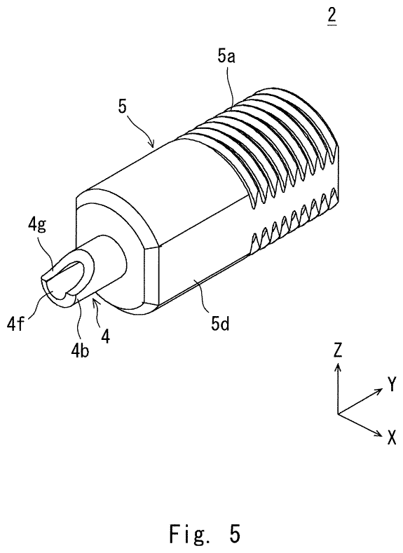

FIG. 4 is a transparent perspective view from the positive side of the y-axis showing the socket connector in the connector unit according to this embodiment. FIG. 5 is a perspective view from the negative side of the y-axis showing the socket connector in the connector unit according to this embodiment.

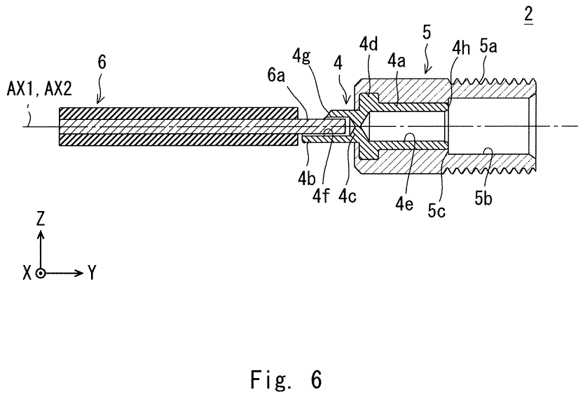

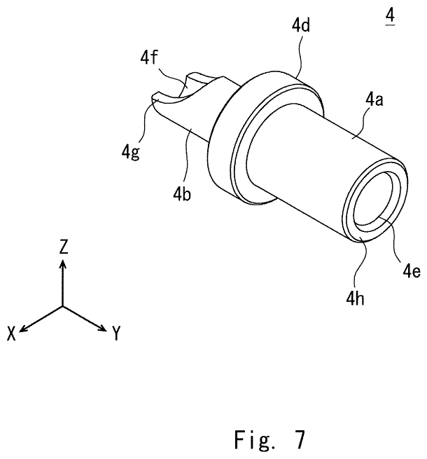

FIG. 6 is a cross-sectional view of the socket connector in the connector unit according to this embodiment. FIG. 7 is a perspective view from the positive side of the y-axis showing a socket terminal of the socket connector in the connector unit according to this embodiment.

As shown in FIGS. 4 to 6, the socket connector 2 includes a socket terminal 4 and a holding member 5. The socket terminal 4 is made of a conductive metal material, and as shown in FIGS. 6 and 7, it includes a first tubular part 4a, a second tubular part 4b, a partition wall 4c, and a flange part 4d.

As shown in FIG. 7, the first tubular part 4a has a substantially cylindrical shape and extends in the y-axis direction. As shown in FIG. 2, the internal space of the first tubular part 4a serves as a first insertion part 4e into which an end of a pin terminal 10 on the negative side of the y-axis in the pin connector 3 is to be inserted.

As shown in FIG. 7, the second tubular part 4b has a substantially cylindrical shape and extends in the y-axis direction. The second tubular part 4b is disposed on the negative side of the y-axis relative to the first tubular part 4a and is continuous with the first tubular part 4a in the y-axis direction.

As shown in FIG. 6, a center axis AX1 of the second tubular part 4b is preferably disposed to substantially overlap a center axis AX2 of the first tubular part 4a. Further, the outside diameter of the second tubular part 4b is preferably smaller than the outside diameter of the first tubular part 4a, and the inside diameter of the second tubular part 4b is preferably smaller than the inside diameter of the first tubular part 4a.

As shown in FIG. 6, the internal space of the second tubular part 4b serves as a second insertion part 4f into which a conductor 6a of a first wire 6 is to be inserted. In the state where the conductor 6a of the first wire 6 is inserted into the second insertion part 4f, the socket terminal 4 and the conductor 6a of the first wire 6 are connected by brazing or the like.

As shown in FIGS. 6 and 7, an end of the second tubular part 4b on the negative side of the y-axis preferably has a notch 4g for connecting the conductor 6a of the first wire 6 to the second tubular part 4b by brazing.

As shown in FIGS. 6 and 7, for example, the notch 4g is preferably disposed at a part on the positive side of the z-axis at the end of the second tubular part 4b on the negative side of the y-axis and curved to the negative side of the z-axis as it goes toward the negative side of the y-axis when viewed from the x-axis direction.

As shown in FIG. 6, the partition wall 4c is disposed between the first tubular part 4a and the second tubular part 4b so as to divide the internal space of the first tubular part 4a and the internal space of the second tubular part 4b.

As shown in FIG. 6, a surface of the partition wall 4c on the positive side of the y-axis is preferably formed in a substantially circular cone shape whose diameter increases as it goes to the positive side of the y-axis so as to allow the pin terminal 10 of the pin connector 3 to be inserted in a suitable manner. Further, a surface of the partition wall 4c on the negative side of the y-axis is preferably formed in a substantially circular cone shape whose diameter increases as it goes to the negative side of the y-axis so as to allow the conductor 6a of the first wire 6 to be inserted in a suitable manner.

As shown in FIG. 7, the flange part 4d projects outward in the radial direction of the first tubular part 4a from an end of the first tubular part 4a on the negative side of the y-axis, and it has a substantially annular shape when viewed from the y-axis direction. As shown in FIG. 6, for example, the flange part 4d is preferably disposed slightly on the positive side of the y-axis relative to the partition wall 4c.

The holding member (socket-side holding member) 5 is made of an insulating resin material, and as shown in FIGS. 4 and 6, it covers the outer peripheral surface of the socket terminal 4 in an airtight manner. The holding member 5 has a substantially cylindrical shape and extends in the y-axis direction. As shown in FIG. 5, an external thread 5a is formed on a part of the outer peripheral surface of the holding member 5 on the positive side of the y-axis.

As shown in FIG. 6, for example, the holding member 5 is preferably formed integrally with the socket terminal 4 by insert molding so as to cover in an airtight manner a part of the outer peripheral surface of the socket terminal 4 on the positive side of the y-axis from an end of the second tubular part 4b on the positive side of the y-axis.

Thus, as shown in FIG. 6, the inner peripheral surface of the holding member 5 is in intimate contact with the end of the second tubular part 4b on the positive side of the y-axis and the outer peripheral surfaces of the flange part 4d and the first tubular part 4a in the socket terminal 4, and thereby achieves an airtight structure.

In this manner, the holding member 5 is formed to cover the flange part 4d of the socket terminal 4, which allows the socket terminal 4 to be securely fixed to the holding member 5. As shown in FIGS. 4 and 5, the notch 4g of the second tubular part 4b of the socket terminal 4 projects to the negative side of the y-axis from the holding member 5.

As shown in FIGS. 2 and 6, a part of the internal space of the holding member 5 on the positive side of the y-axis relative to the socket terminal 4 serves as an insertion part (i.e., recessed part) 5b into which a holding member 12 of the pin connector 3 is to be inserted. An end face 4h of the socket terminal 4 on the positive side of the y-axis is exposed at an end face 5c of the insertion part 5b on the negative side of the y-axis (i.e., a bottom face of the insertion part 5b).

As shown in FIG. 6, the diameter of the insertion part 5b is greater than the outside diameter of the first tubular part 4a of the socket terminal 4. The end face 5c of the insertion part 5b on the negative side of the y-axis is disposed substantially parallel to the xz-plane and substantially flush with the end face 4h of the socket terminal 4 on the positive side of the y-axis.

As shown in FIGS. 4 and 5, flat faces 5d substantially parallel to the yz-plane are preferably formed at an end on the positive side of the x-axis and an end on the negative side of the x-axis of the holding member 5 so that a worker or the like can hold the socket connector 2 when connecting the socket connector 2 and the pin connector 3.

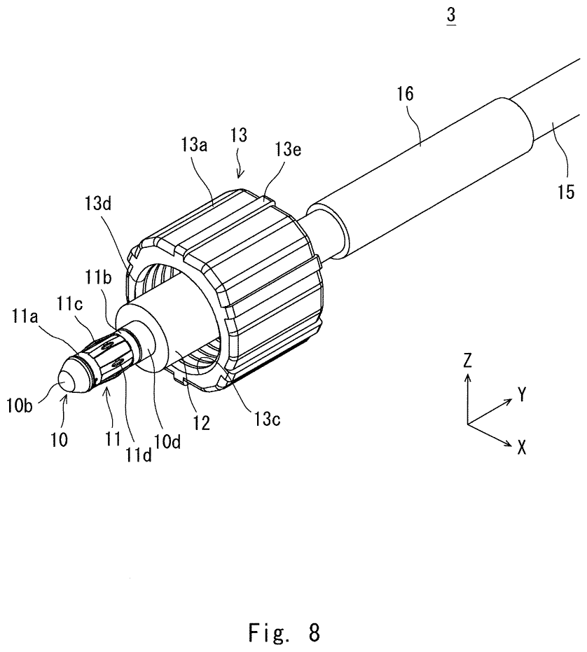

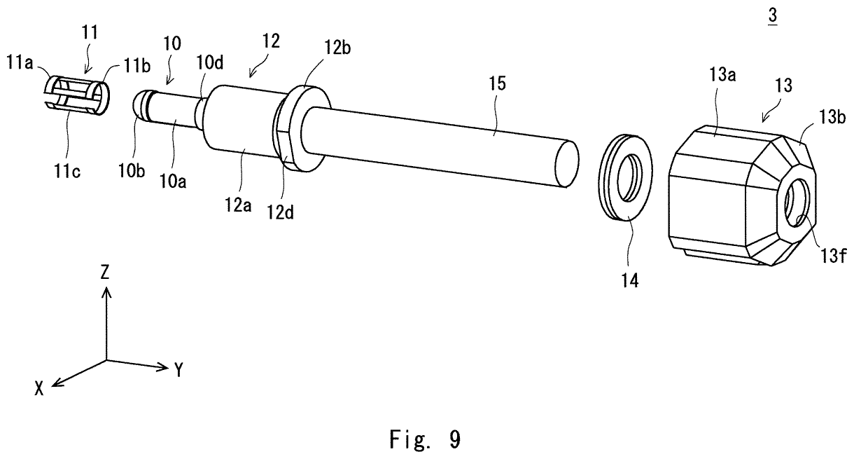

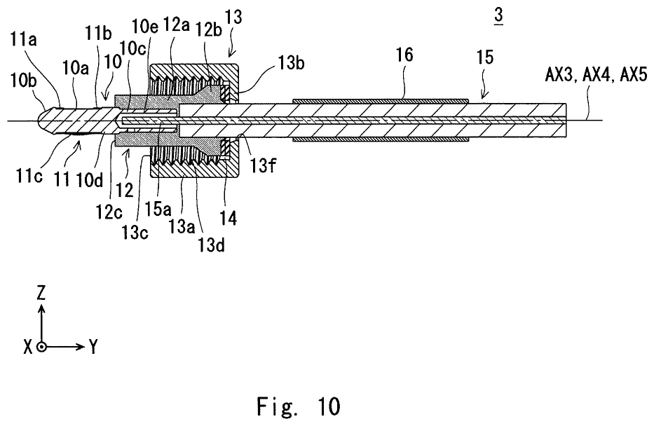

FIG. 8 is a perspective view from the negative side of the y-axis showing the pin connector in the connector unit according to this embodiment. FIG. 9 is an exploded view from the positive side of the y-axis showing the pin connector in the connector unit according to this embodiment. FIG. 10 is a cross-sectional view of the pin connector in the connector unit according to this embodiment.

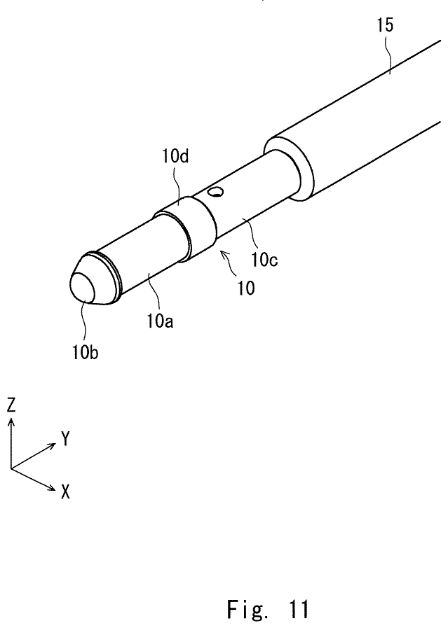

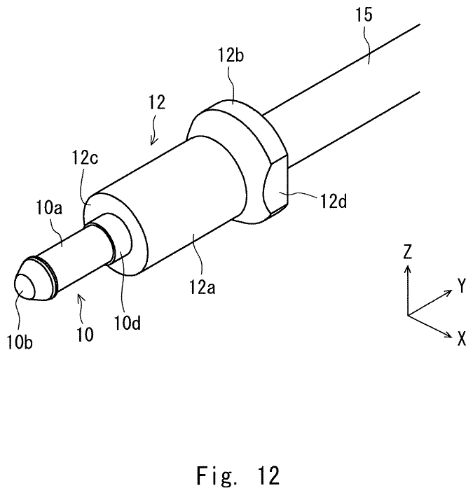

FIG. 11 is a perspective view from the negative side of the y-axis showing the state where the pin terminal of the pin connector in the connector unit according to this embodiment is connected to a second wire. FIG. 12 is a perspective view showing the state where the holding member of the pin connector is integrated with the pin terminal in the connector unit according to this embodiment.

As shown in FIGS. 8 to 10, the pin connector 3 includes the pin terminal 10, a contact 11, the holding member 12, a cap 13, and a biasing member 14. The pin terminal 10 is made of a conductive metal material, and it includes a columnar part 10a, a cone part 10b, a tubular part 10c, and a flange part 10d.

As shown in FIG. 11, the columnar part 10a has a substantially columnar shape and extends in the y-axis direction. The diameter of the columnar part 10a is smaller than the inside diameter of the first insertion part 4e of the socket terminal 4 in the socket connector 2.

As shown in FIG. 11, the cone part 10b is formed in a substantially circular cone shape whose diameter decreases as it goes to the negative side of the y-axis. The cone part 10b is disposed on the negative side of the y-axis relative to the columnar part 10a and is continuous with the columnar part 10a in the y-axis direction.

As shown in FIG. 10, a center axis AX3 of the cone part 10b is preferably disposed to substantially overlap a center axis AX4 of the columnar part 10a. Further, the outside diameter of an end of the cone part 10b on the positive side of the y-axis is preferably substantially equal to the inside diameter of the first insertion part 4e of the socket terminal 4 in the socket connector 2.

Further, a total length including the length of the columnar part 10a in the y-axis direction and the length of the cone part 10b in the y-axis direction is preferably slightly shorter than the length of the first insertion part 4e of the socket terminal 4 in the y-axis direction in the socket connector 2.

As shown in FIG. 11, the tubular part 10c has a substantially cylindrical shape and extends in the y-axis direction. The tubular part 10c is disposed on the positive side of the y-axis relative to the columnar part 10a and is continuous with the columnar part 10a in the y-axis direction.

As shown in FIG. 10, a center axis AX5 of the tubular part 10c is preferably disposed to substantially overlap a center axis AX4 of the columnar part 10a. Further, the outside diameter of the tubular part 10c is preferably substantially equal to the outside diameter of the columnar part 10a.

As shown in FIG. 10, the internal space of the tubular part 10c serves as an insertion part 10e into which a conductor 15a of a second wire 15 is to be inserted. By swaging the tubular part 10c in the state where the conductor 15a of the second wire 15 is inserted into the insertion part 10e, the pin terminal 10 and the conductor 15a of the second wire 15 are connected.

As shown in FIG. 11, the flange part 10d projects outward in the radial direction of the columnar part 10a from an end of the columnar part 10a on the positive side of the y-axis, and it has a substantially annular shape when viewed from the y-axis direction. The outside diameter of the flange part 10d is preferably substantially equal to the inside diameter of the first insertion part 4e of the socket terminal 4 in the socket connector 2.

The contact 11 is made of a conductive metal material and, as shown in FIGS. 8 and 9, it is a substantially barreled leaf spring. In more detail, the contact 11 includes a first tubular part 11a, a second tubular part 11b, and a leaf spring body 11c. The first tubular part 11a is a plate body that is curved in a substantially C-shape when viewed from the y-axis direction, and it extends in the y-axis direction.

As shown in FIG. 10, the inside diameter of the first tubular part 11a is substantially equal to the diameter of the columnar part 10a of the pin terminal 10. Further, the outside diameter of the first tubular part 11a is slightly smaller than the inside diameter of the first insertion part 4e of the socket terminal 4 in the socket connector 2. As shown in FIGS. 8 and 9, the second tubular part 11b has substantially the same shape as the first tubular part 11a and is disposed on the positive side of the y-axis relative to the first tubular part 11a.

As shown in FIGS. 8 and 9, the leaf spring body 11c is a plate body that is curved in a convex shape outward in the radial direction of the contact 11, and it extends in the y-axis direction. The leaf spring body 11c is arranged at spacings in the circumferential direction of the contact 11 and connects the first tubular part 11a and the second tubular part 11b. A contact point 11d that projects outward in the radial direction of the contact 11 is formed at a bending part of the leaf spring body 11c.

As shown in FIGS. 8 and 10, the contact 11 is disposed between the cone part 10b and the flange part 10d of the pin terminal 10 in the state where the columnar part 10a of the pin terminal 10 is disposed inside the contact 11.

The holding member (pin-side holding member) 12 is made of an insulating elastic material such as silicon, and as shown in FIGS. 9, 10, and 12, covers the outer peripheral surface of the pin terminal 10 in an airtight manner. The holding member 12 is preferably formed integrally with the pin terminal 10 by insert molding so as to cover in an airtight manner an end of the flange part 10d on the positive side of the y-axis and the outer peripheral surface of the tubular part 10c in the pin terminal 10 and a connection part between the pin terminal 10 and the second wire 15, for example.

As shown in FIGS. 9, 10, and 12, the holding member 12 includes a tubular part 12a and a flange part 12b. The tubular part 12a has a substantially cylindrical shape and extends in the y-axis direction. The inner peripheral surface of the tubular part 12a is in intimate contact with the end of the flange part 10d on the positive side of the y-axis and the outer peripheral surface of the tubular part 10c in the pin terminal 10 and the connection part between the pin terminal 10 and the second wire 15 and thereby achieves an airtight structure.

As shown in FIG. 2, the outside diameter of the tubular part 12a is substantially equal to the diameter of the insertion part 5b of the holding member 5 in the socket connector 2. As shown in FIG. 12, an end face of the tubular part 12a on the negative side of the y-axis (i.e., an end face of the holding member 12 on the negative side of the y-axis) 12c is disposed substantially parallel to the xz-plane.

As shown in FIGS. 9 and 12, the flange part 12b projects outward in the radial direction of the tubular part 12a from an end of the tubular part 12a on the positive side of the y-axis. As shown in FIG. 2, the length of a part of the tubular part 12a on the negative side of the y-axis relative to the flange part 12b is substantially equal to the length of the insertion part 5b of the holding member 5 of the socket connector 2 in the y-axis direction.

As shown in FIGS. 9 and 12, the flange part 12b has a substantially annular shape when viewed from the y-axis direction. As shown in FIG. 2, the outside diameter of the flange part 12b is smaller than the outside diameter of the holding member 5 of the socket connector 2.

As shown in FIG. 12, an end face of the flange part 12b on the negative side of the y-axis is preferably formed in a substantially circular cone shape whose diameter increases as it goes to the positive side of the y-axis. As shown in FIG. 9, an end face of the flange part 12b on the positive side of the y-axis is preferably disposed substantially parallel to the x-plane. Further, flat faces 12d substantially parallel to the yz-plane are preferably formed at an end on the positive side of the x-axis and an end on the negative side of the x-axis of the flange part 12b.

The cap 13 is made of an insulating resin material, for example, and as shown in FIG. 9, it includes a tubular part 13a and a flange part 13b. The outside shape of the tubular part 13a is substantially rectangular, for example, when viewed from the y-axis direction, and the inside shape of the tubular part 13a is substantially circular.

As shown in FIG. 2, the internal space of the tubular part 13a serves as an insertion part 13c into which an end of the holding member 5 on the positive side of the y-axis in the socket connector 2 is to be inserted. The inside diameter of the tubular part 13a is substantially equal to the outside diameter of the holding member 5 in the socket connector 2.

As shown in FIG. 2, an internal thread 13d into which the external thread 5a of the holding member 5 in the socket connector 2 is to be screwed is formed on the inner peripheral surface of the tubular part 13a. As shown in FIG. 8, on the outer peripheral surface of the tubular part 13a, a projecting part 13e extending in the y-axis direction is preferably formed so that a worker's hand does not slip when screwing the internal thread 13d of the cap 13 into the external thread 5a of the holding member 5 in the socket connector 2.

As shown in FIG. 9, the flange part 13b projects inward in the radial direction of the tubular part 13a from an end of the tubular part 13a on the positive side of the y-axis. Further, a penetration hole 13f extending in the y-axis direction is at substantially the center of the flange part 13b when viewed in the y-axis direction. The diameter of the penetration hole 13f is greater than the diameter of the second wire 15.

As shown in FIG. 10, the cap 13 lets through the second wire 15 so as to cover a part of the holding member 12 on the positive side of the y-axis. In the case where a shrinkage tube 16 that lets through the second wire 15 is fixed to a part of the second wire 15 on the negative side of the y-axis, it prevents the cap 13 from moving to the positive side of the y-axis.

The biasing member 14 is made of an insulating resin material, and as shown in FIG. 9, for example, it may be a Teflon (registered trademark) washer. As shown in FIG. 10, the biasing member 14 lets through the second wire 15 and is disposed in the insertion part 13c of the cap 13 and is thereby disposed between the flange part 12b of the holding member 12 and the flange part 13b of the cap 13.

Although two biasing members 14 are included in the illustrated example such as FIG. 9, the number of biasing members 14 may be modified as appropriate. Further, the biasing member 14 may be a coil spring or the like, and it may have any structure as long as it can exert a force on the holding member 12 to the negative side of the y-axis.

An example of the flow of assembling the socket connector 2 of the connector unit 1 according to this embodiment is described hereinafter. The socket connector 2 is assembled by integrally forming a part of the socket terminal 4 on the positive side of the y-axis from an end of the second tubular part 4b on the positive side of the y-axis with the holding member 5 by insert molding.

An example of the flow of assembling the pin connector 3 of the connector unit 1 according to this embodiment is described hereinafter. First, let the shrinkage tube 16 through the second wire 15 and fix it. Next, insert the conductor 15a of the second wire 15 into the insertion part 10e of the pin terminal 10 and swag the tubular part 10c to thereby connect the pin terminal 10 and the second wire 15.

Then, insert the pin terminal 10 into the contact 11, and place the contact 11 between the cone part 10b and the flange part 10d of the pin terminal 10. Further, pass the second wire 15 to which the pin terminal 10 is connected through the penetration hole 13f of the flange part 13b of the cap 13 from the positive side of the y-axis to the negative side of the y-axis and further pass it through the biasing member 14.

After that, place the cap 13 and the biasing member 14 along the second wire 15 on the positive side of the y-axis, and form an end of the flange part 10d on the positive side of the y-axis and the tubular part 10c in the pin terminal 10 and a connection part between the pin terminal 10 and the second wire 15 integrally with the holding member 12 by insert molding, thereby assembling the pin connector 3. Note that although the pin connector 3 includes the second wire 15 in this embodiment, it may be configured without the second wire 15 connected.

The flow of connecting the socket connector 2 and the pin connector 3 of the connector unit 1 according to this embodiment is described hereinafter. For example, connect the conductor 6a of the first wire 6 to the socket terminal 4 of the socket connector 2 and move the cap 13 of the pin connector 3 to the positive side of the y-axis along the second wire 15, and then insert the end of the pin terminal 10 on the negative side of the y-axis and the contact 11 in the pin connector 3 into the first insertion part 4e of the socket terminal 4 in the socket connector 2.

Then, insert a part of the holding member 12 on the negative side of the y-axis in the pin connector 3 into the insertion part 5b of the holding member 5 in the socket connector 2, and bring the end face 12c of the holding member 12 on the negative side of the y-axis in the pin connector 3 into contact with the end face 4h of the socket terminal 4 on the positive side of the y-axis in the socket connector 2.

At the same time, bring the end face 12c of the holding member 12 on the negative side of the y-axis in the pin connector 3 into contact with the end face 5c of the insertion part 5b of the holding member 5 on the negative side of the y-axis in the socket connector 2. Further, bring the outer peripheral surface of the tubular part 12a of the holding member 12 in the pin connector 3 into contact with the peripheral surface of the insertion part 5b of the holding member 5 in the socket connector 2.

Since the holding member 12 of the pin connector 3 is made of an elastic material, the end face 12c of the holding member 12 on the negative side of the y-axis in the pin connector 3 comes into intimate contact with the end face 4h of the socket terminal 4 on the positive side of the y-axis in the socket connector 2, thereby achieving an airtight structure.

At the same time, the end face 12c of the holding member 12 on the negative side of the y-axis in the pin connector 3 comes into intimate contact with the end face 5c of the insertion part 5b of the holding member 5 on the negative side of the y-axis in the socket connector 2, thereby achieving an airtight structure. Further, the outer peripheral surface of the tubular part 12a of the holding member 12 in the pin connector 3 comes into intimate contact with the peripheral surface of the insertion part 5b of the holding member 5 in the socket connector 2, thereby achieving an airtight structure.

Further, the outer peripheral surface of the socket terminal 4 in the socket connector 2 is covered in an airtight manner with the holding member 5 to achieve an airtight structure, and the outer peripheral surface of the pin terminal 10 in the pin connector 3 is covered in an airtight manner with the holding member 12 to achieve an airtight structure.

Then, move the cap 13 of the pin connector 3 to the negative side of the y-axis along the second wire 15, and insert a part of the holding member 12 on the positive side of the y-axis in the pin connector 3 and a part of the holding member 5 on the positive side of the y-axis in the socket connector 2 into the insertion part 13c of the cap 13 and screw the internal thread 13d of the cap 13 into the external thread 5a of the holding member 5 in the socket connector 2, thereby connecting the socket connector 2 and the pin connector 3.

At this time, the biasing member 14 exerts a force on the holding member 12 toward the negative side of the y-axis while exerting a reaction force on the flange part 13b of the cap 13, and thereby brings the end face 12c of the holding member 12 on the negative side of the y-axis in the pin connector 3 into contact with the end face 4h of the socket terminal 4 on the positive side of the y-axis in the socket connector 2 and further brings the end face 12c of the holding member 12 on the negative side of the y-axis in the pin connector 3 into contact with the end face 5c of the insertion part 5b of the holding member 5 on the negative side of the y-axis in the socket connector 2.

In this manner, with the above-described airtight structure, the connector unit 1 according to this embodiment is capable of controlling partial discharge in the connection state of the socket connector 2 and the pin connector 3. The connector unit 1 according to this embodiment uses an elastic member as the holding member 12 that holds the pin terminal 10 of the pin connector 3.

This eliminates the need to prepare a seal packing in addition to the holding member 5 of the socket connector 2 and the holding member 12 of the pin connector 3 in order to achieve an airtight structure around the socket terminal 4 and the pin terminal 10 in the connection state of the socket connector 2 and the pin connector 3, which allows achieving an airtight structure around the socket terminal 4 and the pin terminal 10 with a smaller number of parts compared with the connector unit 100 according to Patent Literature 1. This allows the connector unit 1 according to this embodiment to be reduced in size and manufactured at lower cost and with simpler processes compared with the connector unit 100 according to Patent Literature 1.

Particularly, since the holding member 12 of the pin connector 3 is an elastic member in the connector unit 1 according to this embodiment, even if a manufacturing error occurs in the holding member 12 or the like, it is capable of bringing the end face 12c of the holding member 12 on the negative side of the y-axis in the pin connector 3 into contact with the end face 4h of the socket terminal 4 on the positive side of the y-axis in the socket connector 2 and suitably bringing the end face 12c of the holding member 12 on the negative side of the y-axis in the pin connector 3 into contact with the end face 5c of the insertion part 5b of the holding member 5 on the negative side of the y-axis in the socket connector 2.

Further, the outer peripheral surface of the tubular part 12a of the holding member 12 in the pin connector 3 is in contact with the peripheral surface of the insertion part 5b of the holding member 5 in the socket connector 2 in the connector unit 1 according to this embodiment. It is therefore capable of preventing the holding member 12 of the pin connector 3 from being deformed in the radial direction of the holding member 12 when the end face 12c of the holding member 12 on the negative side of the y-axis in the pin connector 3 comes into contact with the end face 4h of the socket terminal 4 on the positive side of the y-axis in the socket connector 2 and the end face 12c of the holding member 12 on the negative side of the y-axis in the pin connector 3 comes into contact with the end face 5c of the insertion part 5b of the holding member 5 on the negative side of the y-axis in the socket connector 2, thereby avoiding a failure in the above-described connection state.

In addition, in the case where the end face 4h of the socket terminal 4 on the positive side of the y-axis and the end face 5c of the insertion part 5b of the holding member 5 on the negative side of the y-axis in the socket connector 2 are substantially flush with each other in the connector unit 1 according to this embodiment, it is capable of easily bringing the end face 4h of the socket terminal 4 on the positive side of the y-axis and the end face 5c of the insertion part 5b of the holding member 5 on the negative side of the y-axis in the socket connector 2 into contact with the end face 12c of the holding member 12 on the negative side of the y-axis in the pin connector 3.

Further, in the case of integrally forming the socket terminal 4 and the holding member 5 by insert molding in the connector unit 1 according to this embodiment, it is capable of easily achieving a structure where the holding member 5 covers the outer peripheral surface of the socket terminal 4 in an airtight manner. In the case where the holding member 5 is formed to cover the flange part 4d of the socket terminal 4, the socket terminal 4 is securely fixed to the holding member 5.

Likewise, in the case of integrally forming the pin terminal 10 and the holding member 12 by insert molding in the connector unit 1 according to this embodiment, it is capable of easily achieving a structure where the holding member 12 covers the outer peripheral surface of the pin terminal 10 and a connection part between the pin terminal 10 and the second wire 15 in an airtight manner.

Further, in the case where the holding member 12 includes the flange part 12b in the connector unit 1 according to this embodiment, the area of the biasing member 14 being in contact with the holding member 12 increases, which allows suitably exerting a force on the holding member 12 to the negative side of the y-axis.

Note that the structures of the socket connector 2 and the pin connector 3 according to this embodiment are by way of illustration only, and they may have any structure as long as the holding member 12 of the pin connector 3 is an elastic member, and in the state where the socket connector 2 and the pin connector 3 are connected, the end face 12c of the holding member 12 on the negative side of the y-axis in the pin connector 3 comes into contact with the end face 4h of the socket terminal 4 on the positive side of the y-axis in the socket connector 2 and the end face 12c of the holding member 12 on the negative side of the y-axis in the pin connector 3 comes into contact with the end face 5c of the insertion part 5b of the holding member 5 on the negative side of the y-axis in the socket connector 2.

Further, the flow of assembling the socket connector 2 and the pin connector 3 according to this embodiment is by way of illustration only, and the order of assembly is not particularly limited.

### Second Embodiment

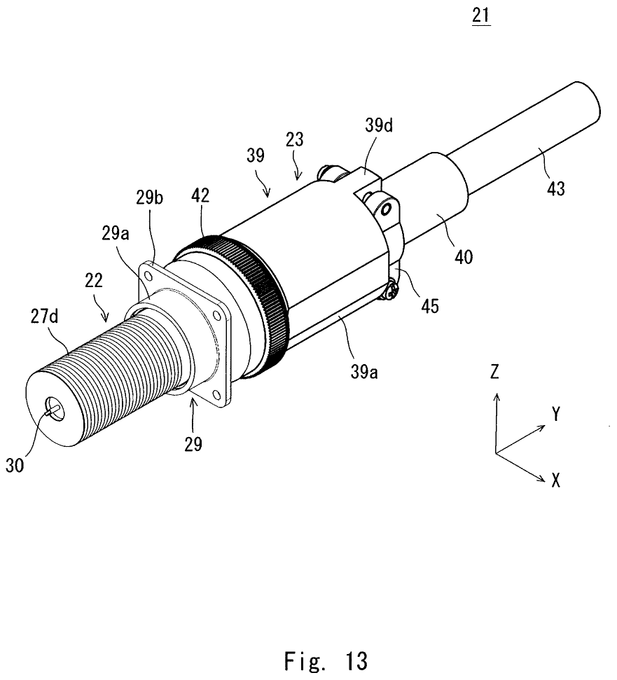

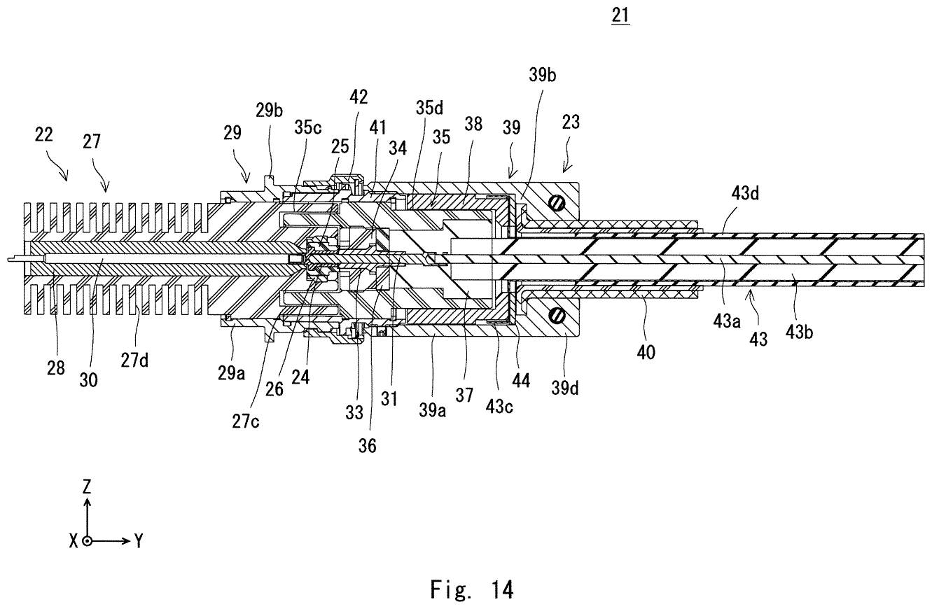

FIG. 13 is a perspective view from the negative side of the y-axis showing the state where a socket connector and a pin connector are connected in a connector unit according to this embodiment. FIG. 14 is a cross-sectional view showing the state where the socket connector and the pin connector are connected in the connector unit according to this embodiment.

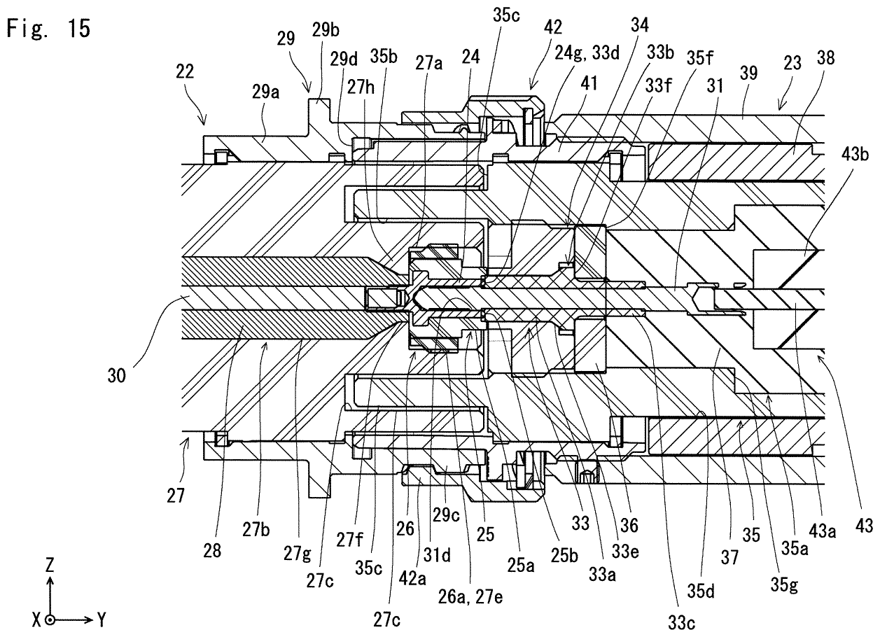

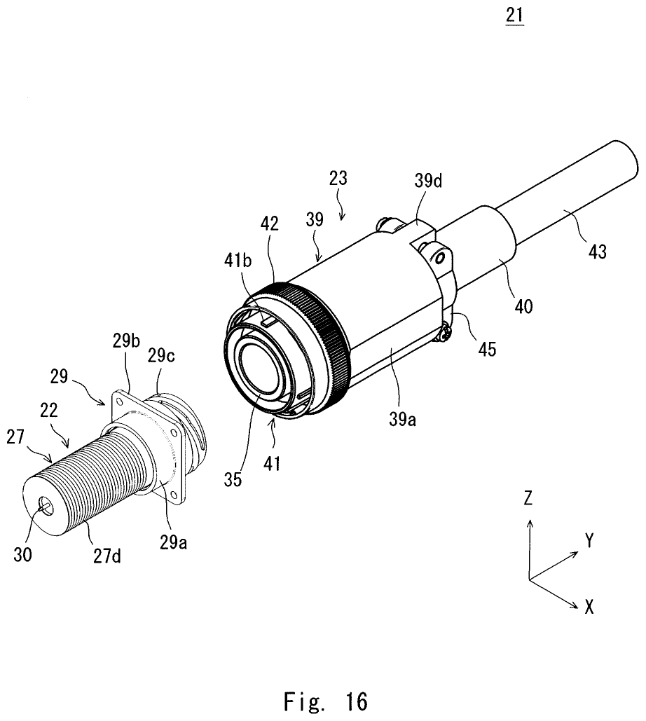

FIG. 15 is a cross-sectional view showing, in a magnified fashion, the state where the socket connector and the pin connector are connected in the connector unit according to this embodiment. FIG. 16 is a perspective view from the negative side of the y-axis showing the state where the socket connector and the pin connector are not connected in the connector unit according to this embodiment. A connector unit 21 according to this embodiment includes a socket connector 22 and a pin connector 23, for example, as shown in FIGS. 13 to 16.

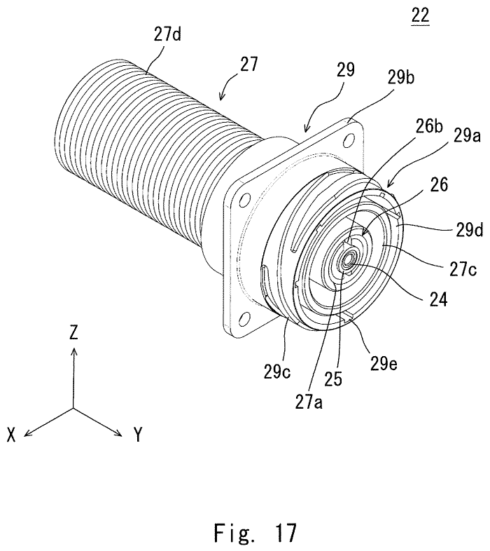

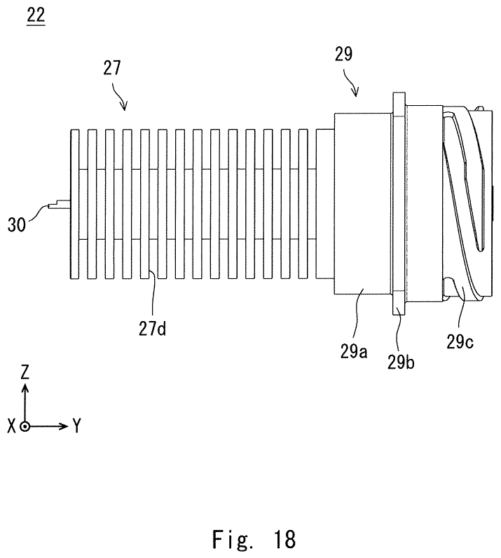

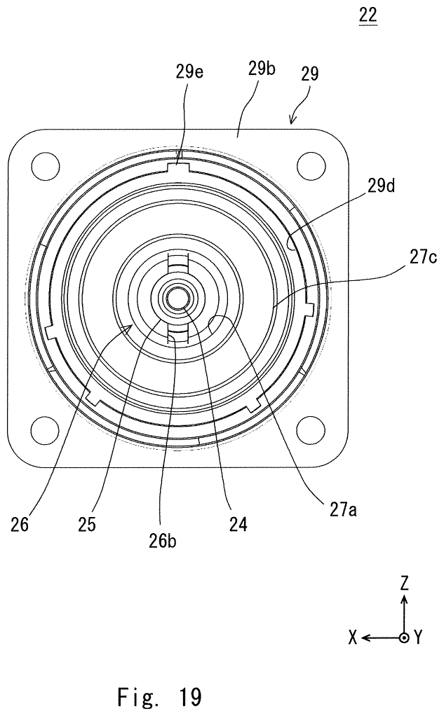

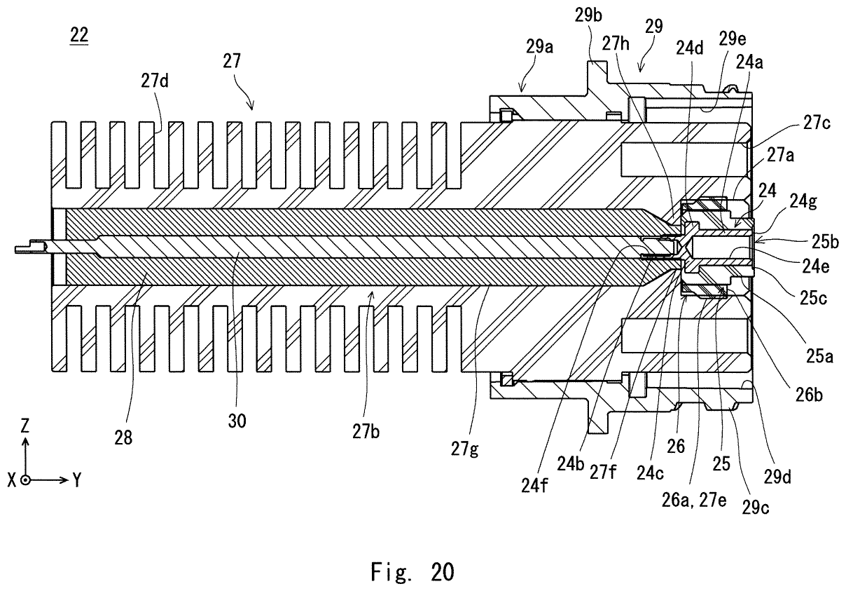

FIG. 17 is a perspective view from the positive side of the y-axis showing the socket connector in the connector unit according to this embodiment. FIG. 18 is a view from the positive side of the x-axis showing the socket connector in the connector unit according to this embodiment. FIG. 19 is a view from the positive side of the y-axis showing the socket connector in the connector unit according to this embodiment. FIG. 20 is a cross-sectional view of the socket connector in the connector unit according to this embodiment.

As shown in FIGS. 17 to 20, the socket connector 22 includes a socket terminal 24, a first holding member 25, a second holding member 26, an insulator 27, a resin member 28, and a shell 29. The socket terminal 24 is made of a conductive metal material, and it includes a first tubular part 24a, a second tubular part 24b, a partition wall 24c, and a flange part 24d.

As shown in FIGS. 14 to 15 and 20, the first tubular part 24a has a substantially cylindrical shape and extends in the y-axis direction. The internal space of the first tubular part 24a serves as a first insertion part 24e into which an end of a pin terminal 31 on the negative side of the y-axis in the pin connector 23 is to be inserted.

As shown in FIG. 20, the second tubular part 24b has a substantially cylindrical shape and extends in the y-axis direction. The second tubular part 24b is disposed on the negative side of the y-axis relative to the first tubular part 24a and is continuous with the first tubular part 24a in the y-axis direction.

As shown in FIG. 20, the center axis of the second tubular part 24b is preferably disposed to substantially overlap the center axis of the first tubular part 24a. The internal space of the second tubular part 24b serves as a second insertion part 24f into which an end of a core wire 30 on the positive side of the y-axis is to be inserted. In the state where the end of the core wire 30 on the positive side of the y-axis is inserted into the second insertion part 24f, the socket terminal 24 and the core wire 30 are electrically connected.

As shown in FIG. 20, the partition wall 24c is disposed between the first tubular part 24a and the second tubular part 24b so as to divide the internal space of the first tubular part 24a and the internal space of the second tubular part 24b.

As shown in FIGS. 14, 15 and 20, a surface of the partition wall 24c on the positive side of the y-axis is preferably formed in a substantially circular cone shape whose diameter increases as it goes to the positive side of the y-axis so as to allow the pin terminal 31 of the pin connector 23 to be inserted in a suitable manner. Further, a surface of the partition wall 24c on the negative side of the y-axis is preferably formed in a substantially circular cone shape whose diameter increases as it goes to the negative side of the y-axis so as to allow the core wire 30 to be inserted in a suitable manner.

As shown in FIG. 20, the flange part 24d projects outward in the radial direction of the first tubular part 24a from an end of the first tubular part 24a on the negative side of the y-axis, and it has a substantially annular shape when viewed from the y-axis direction. The flange part 24d is preferably disposed slightly on the positive side of the y-axis relative to the partition wall 24c.

The first holding member (socket-side holding member) 25 is made of an insulating resin material, and as shown in FIG. 20, it covers the outer peripheral surface of the socket terminal 24 in an airtight manner. The first holding member 25 has a substantially cylindrical shape and extends in the y-axis direction. A notch 25a that is cut in the outer peripheral surface of the first holding member 25 is preferably formed at an end of the first holding member 25 on the positive side of the y-axis. The notch 25a has a substantially annular shape when viewed from the y-axis direction.

As shown in FIG. 20, for example, the first holding member 25 is preferably formed integrally with the socket terminal 24 by insert molding so as to cover in an airtight manner the outer peripheral surface of the socket terminal 24 from an end on the negative side of the y-axis to an end on the positive side of the y-axis of the first tubular part 24a.

Thus, as shown in FIG. 20, for example, the inner peripheral surface of the first holding member 25 is in intimate contact with the outer peripheral surface of the first tubular part 24a and the outer peripheral surface of the flange part 24d in the socket terminal 24 and thereby achieves an airtight structure. In this structure, the first holding member 25 projects on the positive side of the y-axis relative to the socket terminal 24.

As shown in FIGS. 14, 15 and 20, the internal space of the first holding member 25 that projects on the positive side of the y-axis relative to the socket terminal 24 serves as an insertion part (i.e., recessed part) 25b into which an end of a first holding member 33 on the negative side of the y-axis in the pin connector 23 is to be inserted. An end face 24g of the socket terminal 24 on the positive side of the y-axis is exposed at an end face 25c of the insertion part 25b on the negative side of the y-axis.

As shown in FIG. 20, the diameter of the insertion part 25b is greater than the outside diameter of the first tubular part 24a of the socket terminal 24. The end face 25c of the insertion part 25b on the negative side of the y-axis is disposed substantially parallel to the xz-plane and substantially flush with the end face 24g of the socket terminal 24 on the positive side of the y-axis.

The second holding member 26 is made of an insulating resin material. As shown in FIG. 20, for example, the second holding member 26 has a substantially cylindrical shape and extends in the y-axis direction. The inner peripheral surface of the second holding member 26 is in a shape corresponding to the outer peripheral surface of the first holding member 25.

As shown in FIG. 20, the second holding member 26 holds the first holding member 25 in the state where the first holding member 25 is inserted inside the second holding member 26 so as to cover the first holding member 25. An end of the first holding member 25 on the negative side of the y-axis and an end of the second holding member 26 on the negative side of the y-axis are preferably disposed at substantially the same position in the y-axis direction.

As shown in FIG. 20, for example, an external thread 26a is preferably formed on the outer peripheral surface of the second holding member 26. Further, as shown in FIGS. 17 and 19, for example, an insertion part 26b into which a tool for screwing and fixing the second holding member 26 into a first penetration part 27a of the insulator 27 is to be inserted is preferably formed at an end of the second holding member 26 on the positive side of the y-axis.

As shown in FIGS. 17 to 20, for example, the insulator 27 has a substantially cylindrical shape and extends in the y-axis direction. The insulator 27 includes the first penetration part 27a, a second penetration part 27b, an insertion part 27c, and a groove 27d. The first penetration part 27a is disposed on the positive side of the y-axis of the insulator 27. The diameter of the first penetration part 27a is substantially the same as the outside diameter of the second holding member 26.

As shown in FIG. 20, for example, an internal thread 27e is preferably formed on the peripheral surface of the first penetration part 27a. Preferably, the external thread 26a of the second holding member 26 is screwed into the internal thread 27e of the first penetration part 27a, and the second holding member 26 is inserted inside the first penetration part 27a and fixed to the insulator 27.

As shown in FIG. 20, the second penetration part 27b is continuous with the first penetration part 27a and disposed on the negative side of the y-axis relative to the first penetration part 27a. The center axis of the second penetration part 27b preferably substantially overlap the center axis of the first penetration part 27a.

As shown in FIG. 20, the second penetration part 27b includes a first part 27f and a second part 27g. The first part 27f is disposed on the positive side of the y-axis relative to the second part 27g. The diameter of the first part 27f is preferably smaller than the outside diameter of the flange part 24d of the socket terminal 24.

As shown in FIG. 20, for example, the diameter of the second part 27g is preferably larger than the diameter of the first part 27f. Thus, a flange part 27h that projects inward in the radial direction of the second penetration part 27b is disposed between the first penetration part 27a and the second part 27g of the second penetration part 27b.

This enables positioning of the first holding member 25 and the second holding member 26 in the state where the end of the first holding member 25 on the negative side of the y-axis and the end of the second holding member 26 on the negative side of the y-axis are in contact with an end of the flange part 27h on the positive side of the y-axis as shown in FIG. 20. The core wire 30 is inserted into the second penetration part 27b. The core wire 30 preferably projects on the negative side of the y-axis from the insulator 27.

As shown in FIGS. 14, 15 and 20, the insertion part 27c is formed at an end of the insulator 27 on the positive side of the y-axis, and an end of an insulator 35 on the negative side of the y-axis in the pin connector 23 is inserted thereto. As shown in FIG. 17, the insertion part 27c is a recessed part in a substantially annular ring shape and is disposed to surround the first penetration part 27a when viewed in the y-axis direction.

As shown in FIGS. 18 and 20, the groove 27d is formed on the outer peripheral surface of the insulator 27 in order to increase the creepage distance. As shown in FIG. 17, the grooves 27d extend in the circumferential direction of the insulator 27 and are arranged at substantially regular spacings in the y-axis direction.

As shown in FIG. 20, the resin member 28 fills the second penetration part 27b of the insulator 27. The resin member 28 fixes the socket terminal 24 and the core wire 30. The shell 29 includes a tubular part 29a and a flange part 29b.

As shown in FIGS. 17 to 20, the tubular part 29a has a substantially cylindrical shape and extends in the y-axis direction. The tubular part 29a includes an external thread 29c and an insertion part 29d, for example. The external thread 29c is formed on a part of the outer peripheral surface of the tubular part 29a on the positive side of the y-axis. The external thread 29c is preferably a multi-start thread, for example.

As shown in FIGS. 14, 15 and 20, the insertion part 29d is formed at an end of the tubular part 29a on the positive side of the y-axis, and an end of a third shell 41 on the negative side of the y-axis in the pin connector 23 is to be inserted thereto. The insertion part 29d has a substantially annular ring shape when viewed from the y-axis direction, and it is a notch cut in the inner peripheral surface of the insertion part 29d. The insertion part 29d preferably has a recessed part 29e that extends in the y-axis direction as shown in FIGS. 17 and 19, for example.

As shown in FIG. 20, the flange part 29b projects outward in the radial direction from the tubular part 29a. The flange part 29b is, for example, used when fixing the socket connector 22 to a housing of electronic equipment. The shell 29 is fixed to a part of the insulator 27 on the positive side of the y-axis with the insulator 27 being inserted inside the shell 29, for example.

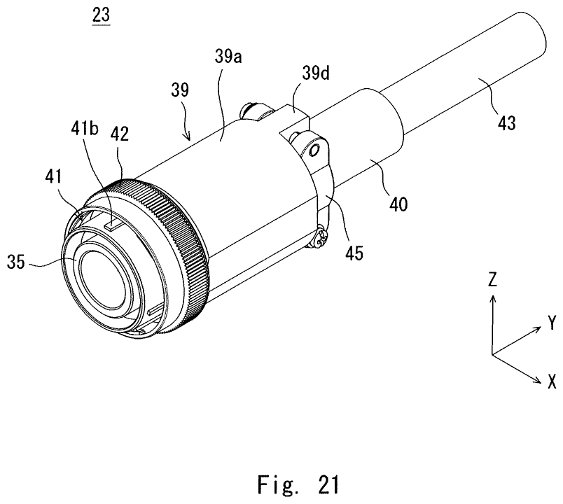

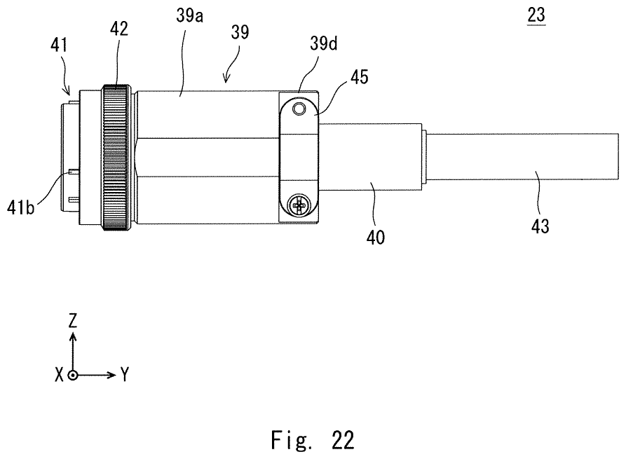

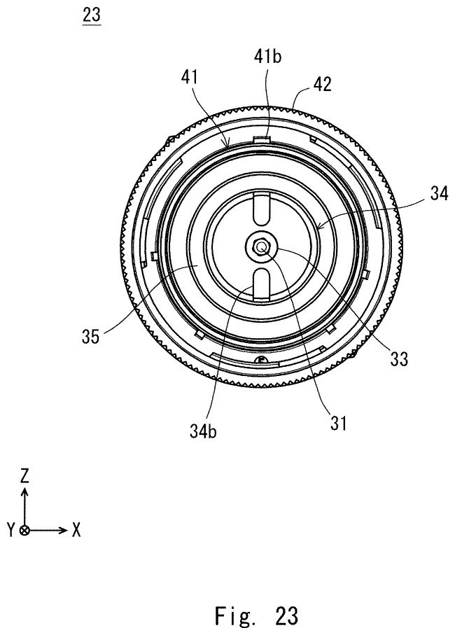

FIG. 21 is a perspective view from the negative side of the y-axis showing the pin connector in the connector unit according to this embodiment. FIG. 22 is a view from the positive side of the x-axis showing the pin connector in the connector unit according to this embodiment. FIG. 23 is a view from the negative side of the y-axis showing the pin connector in the connector unit according to this embodiment.

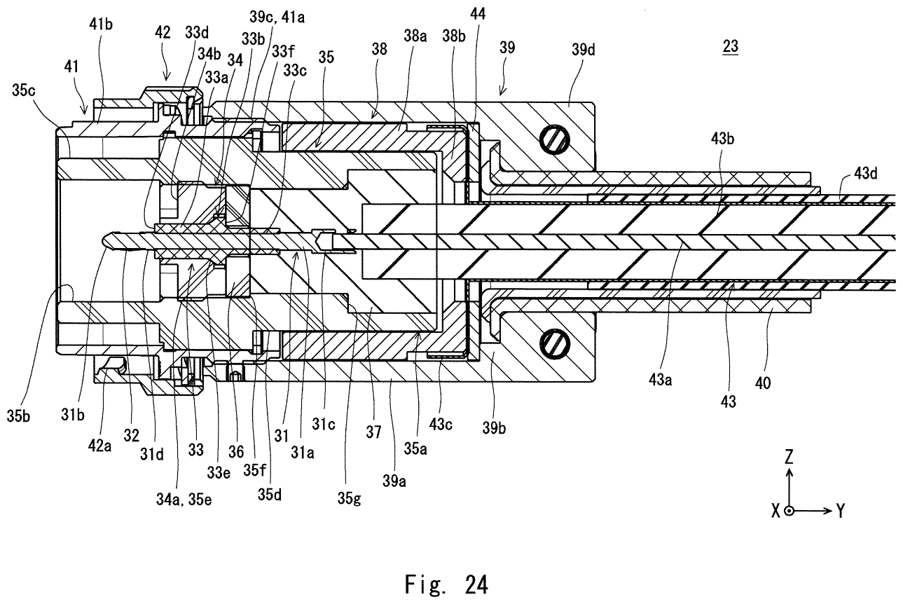

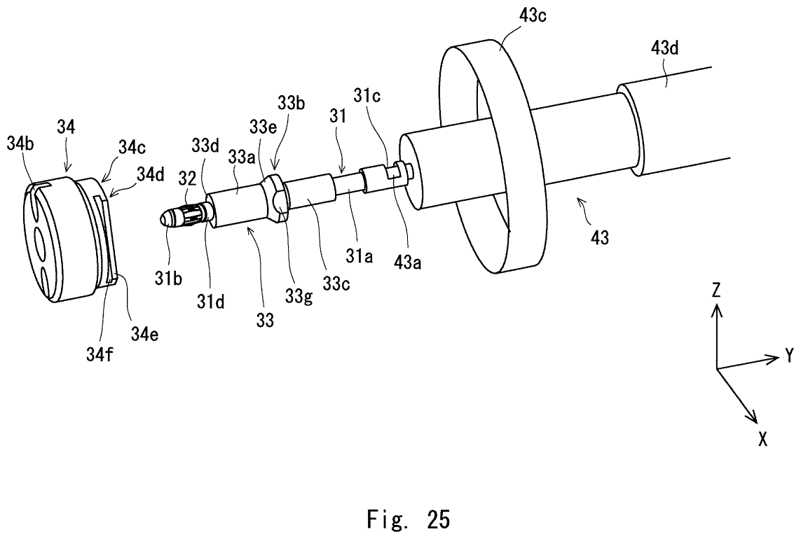

FIG. 24 is a cross-sectional view of the pin connector in the connector unit according to this embodiment. FIG. 25 is an exploded perspective view from the negative side of the y-axis showing a pin terminal, a first holding member, a second holding member and the like in the connector unit according to this embodiment.

As shown in FIGS. 21 to 24, the pin connector 23 includes the pin terminal 31, a contact 32, a first holding member 33, a second holding member 34, the insulator 35, a biasing member 36, a resin member 37, a first shell 38, a second shell 39, an insulating member 40, a third shell 41, and a fourth shell 42.

The pin terminal 31 is made of a conductive metal material, and as shown in FIG. 24, it includes a columnar part 31a, a cone part 31b, a tubular part 31c, and a flange part 31d. The columnar part 31a has a substantially columnar shape and extends in the y-axis direction. As shown in FIGS. 14 and 15, the diameter of the columnar part 31a is smaller than the inside diameter of the first insertion part 24e of the socket terminal 24 in the socket connector 22.

As shown in FIGS. 24 and 25, the cone part 31b is formed in a substantially circular cone shape whose diameter decreases as it goes to the negative side of the y-axis. The cone part 31b is disposed on the negative side of the y-axis relative to the columnar part 31a and is continuous with the columnar part 31a in the y-axis direction. As shown in FIGS. 14 and 15, the outside diameter of an end of the cone part 31b on the positive side of the y-axis is preferably substantially equal to the inside diameter of the first insertion part 24e of the socket terminal 24 in the socket connector 22.

As shown in FIGS. 24 and 25, the tubular part 31c is disposed at an end of the columnar part 31a on the positive side of the y-axis. The tubular part 31c has a substantially cylindrical shape and projects on the positive side of the y-axis from the columnar part 31a. The center axis of the columnar part 31a, the center axis of the cone part 31b, and the center axis of the tubular part 31c are preferably disposed to substantially overlap with one another. An end of a core wire 43a of the wire 43 on the negative side of the y-axis is inserted into and electrically connected to the tubular part 31c.

As shown in FIGS. 24 and 25, the flange part 31d is disposed on the positive side of the y-axis relative to the cone part 31b. The flange part 31d projects outward in the radial direction of the columnar part 31a from the columnar part 31a, and it has a substantially annular shape when viewed from the y-axis direction. As shown in FIGS. 14 and 15, the outside diameter of the flange part 31d is substantially equal to the inside diameter of the first insertion part 24e of the socket terminal 24 in the socket connector 22.

As shown in FIGS. 14 and 15, the length in the y-axis direction of a part of the pin terminal 31 on the negative side of the y-axis relative to an end of the flange part 31d on the positive side of the y-axis is preferably substantially equal to the length in the y-axis direction of the first insertion part 24e of the socket terminal 24 in the socket connector 22.

As shown in FIG. 25, the contact 32 has substantially the same shape as the contact 11 according to the first embodiment, and it is disposed between the cone part 31b and the flange part 31d of the pin terminal 31 in the state where a part of the columnar part 31a on the negative side of the y-axis of the pin terminal 31 is inserted inside the contact 32.

The first holding member (first pin-side holding member) 33 is made of an insulating elastic material such as silicon, and as shown in FIGS. 24 and 25, covers the outer peripheral surface of the pin terminal 31 in an airtight manner. The first holding member 33 is preferably formed integrally with the pin terminal 31 by insert molding so as to cover in an airtight manner a part of the pin terminal 31 on the positive side of the y-axis including an end of the flange part 31d on the positive side of the y-axis, for example.

As shown in FIGS. 24 and 25, the first holding member 33 includes a tubular part 33a, a flange part 33b, and an extension part 33c. The tubular part 33a has a substantially cylindrical shape and extends in the y-axis direction.

As shown in FIGS. 14 and 15, the outside diameter of the tubular part 33a is substantially equal to the diameter of the insertion part 25b of the first holding member 25 in the socket connector 22. As shown in FIGS. 24 and 25, an end face of the tubular part 33a on the negative side of the y-axis (i.e., an end face of the first holding member 33 on the negative side of the y-axis) 33d is disposed substantially parallel to the xz-plane.

As shown in FIGS. 24 and 25, the flange part 33b projects outward in the radial direction of the tubular part 33a from an end of the tubular part 33a on the positive side of the y-axis. The flange part 33b as a substantially annular shape when viewed from the y-axis direction. An end face 33e of the flange part 33b on the negative side of the y-axis is preferably formed in a substantially circular cone shape whose diameter increases as it goes to the positive side of the y-axis, for example.

As shown in FIGS. 24 and 25, for example, an end face 33f of the flange part 33b on the positive side of the y-axis is preferably disposed substantially parallel to the xz-plane. Further, flat faces 33g substantially parallel to the yz-plane, for example, are preferably formed at an end on the positive side of the x-axis and an end on the negative side of the x-axis of the flange part 33b.

As shown in FIGS. 24 and 25, the extension part 33c has a substantially cylindrical shape and projects on the positive side of the y-axis from the tubular part 33a. The outside diameter of the extension part 33c is preferably smaller than the outside diameter of the tubular part 33a, for example.

As shown in FIGS. 24 and 25, the inner peripheral surface of the tubular part 33a and the inner peripheral surface of the extension part 33c are in intimate contact with a part of the outer peripheral surface of the pin terminal 31 between an end of the flange part 31d on the positive side of the y-axis and the tubular part 31c and thereby achieves an airtight structure. Thus, a part of the pin terminal 31 on the negative side of the y-axis relative to an end of the flange part 31d on the positive side of the y-axis and the tubular part 31c of the pin terminal 31 are exposed from the first holding member 33.

The second holding member (second pin-side holding member) 34 is made of an insulating resin material. As shown in FIGS. 24 and 25, for example, the second holding member 34 has a substantially cylindrical shape and extends in the y-axis direction. The inner peripheral surface of the second holding member 34 is in a shape corresponding to a part of the outer peripheral surface of the first holding member 33 on the negative side of the y-axis including an end of the flange part 33b on the positive side of the y-axis.

As shown in FIG. 24, the second holding member 34 holds the first holding member 33 in the state where the first holding member 33 is inserted inside the second holding member 34 so as to cover the part of the first holding member 33 on the negative side of the y-axis including the end of the flange part 33b on the positive side of the y-axis.

The end of the flange part 33b of the first holding member 33 on the positive side of the y-axis (i.e., the end face 33f of the flange part 33b on the positive side of the y-axis) and the end of the second holding member 34 on the positive side of the y-axis are preferably disposed at substantially the same position in the y-axis direction. The first holding member 33 projects on the negative side of the y-axis from the second holding member 34.

As shown in FIG. 24, for example, an external thread 34a is preferably formed on the outer peripheral surface of the second holding member 34. Further, as shown in FIG. 23, an insertion part 34b into which a tool for screwing and fixing the second holding member 34 into a first penetration part 35a of the insulator 35 is to be inserted is preferably formed at an end of the second holding member 34 on the negative side of the y-axis.

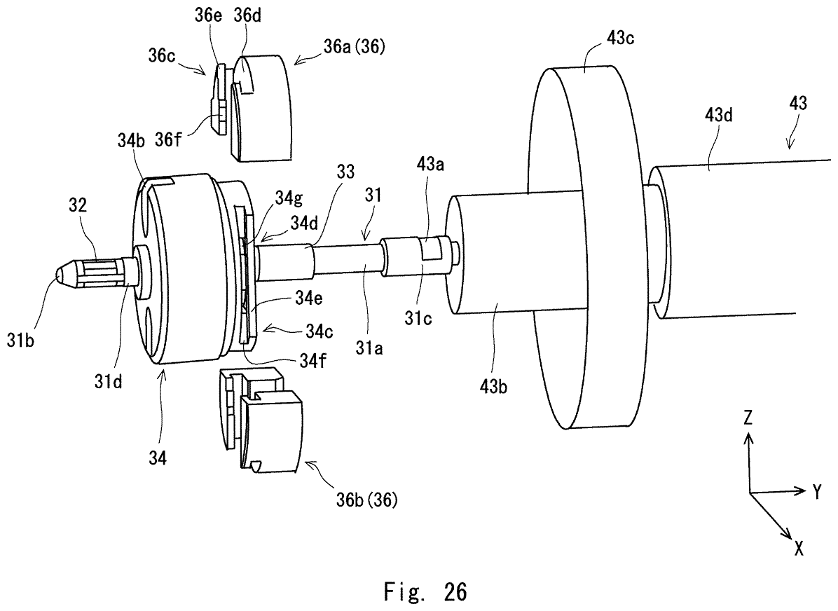

FIG. 26 is a view illustrating an engagement structure of the second holding member and the biasing member of the pin connector in the connector unit according to this embodiment. As shown in FIG. 26, at an end of the second holding member 34 on the positive side of the y-axis, a small diameter part 34c whose diameter is smaller than a part of the second holding member 34 on the negative side of the y-axis is formed.

As shown in FIG. 26, an engaged part 34d is formed in the small diameter part 34c. The engaged part 34d is engaged with an engaging part 36c of the biasing member 36. The engaged part 34d preferably includes a flat part 34e, an insertion part 34f, and a recessed part 34g.

As shown in FIG. 26, the flat parts 34e are formed to cut an end on the positive side of the x-axis and an end on the negative side of the x-axis of the small diameter part 34c. The flat parts 34e are substantially parallel to the yz-plane and opposed to each other in the x-axis direction.

As shown in FIG. 26, the insertion part 34f is formed in each flat parts 34e, and it is a groove extending in the z-axis direction. An end on the positive side of the z-axis and an end on the negative side of the z-axis of each insertion part 34f are open. The recessed parts 34g are formed at the bottom of the insertion part 34f and arranged at spacings from each other in the z-axis direction in the respective insertion parts 34f. The recessed part 34g is recessed parted toward the other insertion part 34f.

The insulator 35 is made of an insulating resin material. As shown in FIG. 24, the insulator 35 has a substantially cylindrical shape and extends in the y-axis direction. The insulator 35 includes the first penetration part 35a, a second penetration part 35b, a first insertion part 35c, and a second insertion part 35d.

As shown in FIG. 24, the second holding member 34 that holds the pin terminal 31 and the first holding member 33, and a wire 43 are inserted inside the first penetration part 35a. The diameter of the first penetration part 35a on the negative side of the y-axis is substantially equal to the outside diameter of the second holding member 34.

As shown in FIG. 24, for example, an internal thread 35e is preferably formed on a part of the peripheral surface of the first penetration part 35a on the negative side of the y-axis. It is further preferred that the external thread 34a of the second holding member 34 is screwed into the internal thread 35e of the first penetration part 35a, and the second holding member 34 is inserted inside the first penetration part 35a and fixed to the insulator 35.

Further, as shown in FIG. 24, a first step part 35f and a second step part 35g are preferably formed in the first penetration part 35a. The first step part 35f is disposed at a boundary part where the diameter decreases compared with a part of the first penetration part 35a on the negative side of the y-axis.

As shown in FIG. 24, the second step part 35g is disposed at a boundary part where the diameter increases compared with a part where the diameter decreases on the border of the first step part 35f in the first penetration part 35a. A dielectric member 43b that covers a core wire 43a in a wire 43 is preferably disposed at a part of the first penetration part 35a on the positive side of the y-axis relative to the second step part 35g.

As shown in FIG. 24, the second penetration part 35b is continuous with the first penetration part 35a and disposed on the negative side of the y-axis relative to the first penetration part 35a. A part of the pin terminal 31 which projects together with the first holding member 33 on the negative side of the y-axis from the second holding member 34 is disposed inside the second penetration part 35b.

As shown in FIGS. 14 and 15, a part of the insulator 27 on the inner side of the radial direction relative to the insertion part 27c of the insulator 27 in the socket connector 22 is inserted into the second penetration part 35b. An end of the insulator 35 on the negative side of the y-axis is inserted into the insertion part 27c of the insulator 27 of the socket connector 22.

As shown in FIG. 24, the first insertion part 35c is disposed at an end of the insulator 35 on the negative side of the y-axis. The first insertion part 35c is a notch cut at an end of the outer peripheral surface of the insulator 35 on the negative side of the y-axis, and it has a substantially annular shape when viewed from the y-axis direction. As shown in FIGS. 14 and 15, a part of the insulator 27 on the outer side of the radial direction relative to the insertion part 27c of the insulator 27 in the socket connector 22 is inserted into the first insertion part 35c.

As shown in FIG. 24, the second insertion part 35d is disposed at an end of the insulator 35 on the positive side of the y-axis. The second insertion part 35d is a notch cut at an end of the outer peripheral surface of the insulator 35 on the positive side of the y-axis, and it has a substantially annular shape when viewed from the y-axis direction.

The biasing member 36 is made of an insulating elastic material, for example. As shown in FIG. 24, for example, the biasing member 36 is preferably a plate body that is in a substantially annular shape when viewed from the y-axis direction. The biasing member 36 is disposed inside the first penetration part 35a of the insulator 35.

As shown in FIG. 24, the extension part 33c of the first holding member 33 is inserted inside the biasing member 36 and interposed between the flange part 33b of the first holding member 33 and the second holding member 34 and the first step part 35f of the first penetration part 35a of the insulator 35.

In this structure, the flange part 33b of the first holding member 33 is caught between the biasing member 36 and the second holding member 34. The position of the pin terminal 31 and the first holding member 33 in the y-axis direction is thereby restricted, and when the first holding member 33 is pushed toward the positive side of the y-axis, the first holding member 33 is biased toward the negative side of the y-axis by the elastic force of the biasing member 36.

Although detailed functions are described later, the biasing member 36 is preferably divided into a plurality of pieces. As shown in FIG. 26, for example, the biasing member 36 is preferably divided into a first divided piece 36a and a second divided piece 36b. Note that since the first divided piece 36a and the second divided piece 36b are in plane symmetry with respect to the xy-plane, the first divided piece 36a is described hereinafter as a representative.

As shown in FIG. 26, the first divided piece 36a is a piece of the biasing member 36 divided in halves in the z-axis direction, and it includes the engaging part 36c. The engaging part 36c includes a recessed part 36d, an insert 36e, and a projecting part 36f. The recessed part 36d is formed at an end of the first divided piece 36a on the negative side of the y-axis, and it is a groove extending in the z-axis direction.

As shown in FIG. 26, the inserts 36e project inward of the recessed part 36d from each of ends of the recessed part 36d on the positive side of the x-axis and on the negative side of the x-axis in the x-axis direction. The inserts 36e are opposed to each other in the x-axis direction and extend in the z-axis direction. The projecting part 36f projects inward of the recessed part 36d from each of the inserts 36e in the x-axis direction.

In the state where the small diameter part 34c of the second holding member 34 is inserted into the recessed part 36d of the first divided piece 36a from the positive side of the z-axis, and the insert 36e of the first divided piece 36a is inserted into the insertion part 34f of the second holding member 34, the projecting part 36f of the first divided piece 36a is engaged with the recessed part 34g of the second holding member 34, so that the first divided piece 36a is fixed to the second holding member 34. Thus, the first divided piece 36a and the second divided piece 36b are fixed in the state of surrounding the extension part 33c of the first holding member 33.

As shown in FIG. 24, the resin member 37 fills a part inside the first penetration part 35a of the insulator 35 on the positive side of the y-axis relative to the biasing member 36. The resin member 37 fixes the pin terminal 31, a connection part between the pin terminal 31 and the core wire 43a of the wire 43, and a part of the wire 43 on the positive side of the y-axis relative to the connection part with the pin terminal 31.

The first shell 38 is made of a conductive metal material. As shown in FIG. 24, the first shell 38 includes a tubular part 38a and a flange part 38b. The tubular part 38a has a substantially cylindrical shape and extends in the y-axis direction. The flange part 38b projects inward in the radial direction of the tubular part 38a from an end of the tubular part 38a on the positive side of the y-axis. The flange part 38b has a substantially annular shape when viewed in the y-axis direction.

As shown in FIG. 24, the first shell 38 is disposed to cover a part of the insulator 35 on the positive side of the y-axis. The wire 43 is drawn inside the flange part 38b of the first shell 38. The tubular part 38a of the first shell 38 is inserted into the second insertion part 35d of the insulator 35 so as to cover the part of the insulator 35 on the positive side of the y-axis.

The second shell 39 is made of a conductive metal material. As shown in FIG. 24, the second shell 39 includes a tubular part 39a and a flange part 39b. The tubular part 39a has a substantially cylindrical shape and extends in the y-axis direction. The flange part 39b projects inward in the radial direction of the tubular part 39a from an end of the tubular part 39a on the positive side of the y-axis. The flange part 39b has a substantially annular shape when viewed in the y-axis direction.

As shown in FIG. 24, the second shell 39 is disposed to cover the first shell 38. The wire 43 is drawn inside the flange part 39b of the second shell 39. A ground shield 43c of the wire 43 is placed between the first shell 38 and the second shell 39 with a conductive spacer 44 interposed therebetween, so that a ground path is established. The tubular part 39a of the second shell 39 projects on the negative side of the y-axis from the first shell 38, and an internal thread 39c is preferably formed on the inner peripheral surface of the projecting part, for example.

As shown in FIGS. 14 and 24, the insulating member 40 covers a part of the wire 43 from which an insulating member 43d is stripped away so that the part where the insulating member 43d is stripped in order to expose the ground shield 43c in the wire 43 is not exposed from the pin connector 23. The insulating member 40 is inserted inside the flange part 39b of the second shell 39 with the wire 43 being inserted inside the insulating member 40.

As shown in FIGS. 21 and 22, for example, it is preferred that a flat part 39d substantially parallel to the yz-plane projects to the positive side of the y-axis from the flange part 39b of the second shell 39, and the insulating member 40 is caught in the x-axis direction between interposing members 45 placed across the flat parts 39d disposed on both sides of the wire 43 in the z-axis direction. This allows the wire 43 to be securely fixed to the second shell 39.

The third shell 41 is made of a conductive metal material. As shown in FIG. 24, the third shell 41 has a substantially cylindrical shape and extends in the y-axis direction. The third shell 41 is held by the insulator 35 in such a way that it is rotatable about the y-axis in the state where the insulator 35 is inserted inside the third shell 41 so as to cover a part of the insulator 35 on the negative side of the y-axis.

As shown in FIG. 24, an end of the third shell 41 on the negative side of the y-axis is disposed at substantially the same position as an end of the insulator 35 on the negative side of the y-axis in the y-axis direction. Further, a part of the third shell 41 on the positive side of the y-axis is disposed between the insulator 35 and the tubular part 39a of the second shell 39.

As shown in FIG. 24, for example, an external thread 41a is preferably formed on a part of the outer peripheral surface of the third shell 41 on the positive side of the y-axis. The external thread 41a of the third shell 41 is preferably screwed into the internal thread 39c of the tubular part 39a of the second shell 39. This allows the third shell 41 to be fixed to the second shell 39.

Further, as shown in FIGS. 21 and 23, for example, a projecting part 41b to be inserted into the recessed part 29e of the shell 29 of the socket connector 22 is preferably formed on a part of the outer peripheral surface of the third shell 41 on the negative side of the y-axis. The projecting part 41b extends in the y-axis direction.

The fourth shell 42 is made of a conductive metal material. As shown in FIGS. 21 and 24, the fourth shell 42 has a substantially cylindrical shape and extends in the y-axis direction. The inside diameter of the fourth shell 42 is larger than the outside diameter of the third shell 41. As shown in FIG. 15, an internal thread 42a into which the external thread 29c of the shell 29 of the socket connector 22 is to be inserted is formed on the inner peripheral surface of the fourth shell 42.

As shown in FIG. 24, the fourth shell 42 is held by the third shell 41 in such a way that it is rotatable about the y-axis in the state where the third shell 41 is inserted inside the fourth shell 42 so as to cover a part of the third shell 41 projecting on the negative side of the y-axis from the second shell 39.

An example of the flow of assembling the socket connector 22 in the connector unit 21 according to this embodiment is described hereinafter. First, electrically connect an end of the core wire 30 on the positive side of the y-axis to the second tubular part 24b of the socket terminal 24. Next, integrally form the socket terminal 24 with the first holding member 25 by insert molding and cover the socket terminal 24 with the first holding member 25.

Then, insert the first holding member 25 into the second holding member 26, and cover the first holding member 25 with the second holding member 26. After that, pass the core wire 30 through the first penetration part 27a and the second penetration part 27b of the insulator 27 from the positive side of the y-axis and screw the external thread 26a of the second holding member 26 into the internal thread 27e of the insulator 27.

The socket terminal 24, the first holding member 25, and the second holding member 26 are thereby inserted into the first penetration part 27a of the insulator 27, and the end of the first holding member 25 on the negative side of the y-axis and the end of the second holding member 26 on the negative side of the y-axis come into contact with the flange part 27h of the insulator 27.

Consequently, the socket terminal 24, the first holding member 25, the second holding member 26, and the core wire 30 are fixed to the insulator 27. It is preferred to insert a tool into the insertion part 26b of the second holding member 26 to screw the second holding member 26. This allows easily screwing and fixing the second holding member 26 into the first penetration part 27a of the insulator 27.

It is preferred to fix the shell 29 beforehand to the insulator 27. After that, introduce the resin member 28 into the second penetration part 27b of the insulator 27 to thereby assemble the socket connector 22.

An example of the flow of assembling the pin connector 23 of the connector unit 21 according to this embodiment is described hereinafter. First, let the contact 32 through the pin terminal 31 and fix it thereto, and electrically connect an end of the core wire 43a of the wire 43 on the negative side of the y-axis to the tubular part 31c of the pin terminal 31. Next, insert the pin terminal 31 and the wire 43 inside the flange part 39b of the second shell 39 through the insulating member 40, and strip the insulating member 43d of the wire 43 to expose the ground shield 43c.

Next, insert the pin terminal 31, the core wire 43a of the wire 43, and the dielectric member 43b inside the flange part 38b of the first shell 38. In this step, the ground shield 43c of the wire 43 is disposed between the first shell 38 and the second shell 39.

Then, insert the first shell 38 inside the second shell 39, so that the ground shield 43c of the wire 43 is placed between the first shell 38 and the second shell 39 with the spacer 44 interposed between. In this step, the core wire 43a of the wire 43 and the dielectric member 43b are drawn to the negative side of the y-axis so as to allow the following step to be conducted on the first shell 38 and the second shell 39.

After that, pass the pin terminal 31, the core wire 43a of the wire 43, and the dielectric member 43b through the first penetration part 35a and the second penetration part 35b of the insulator 35, and expose the core wire 43a of the wire 43 and the dielectric member 43b from the insulator 35 on the negative side of the y-axis. It is preferred in this step that the third shell 41 and the fourth shell 42 are mounted on the insulator 35.

Then, integrally form the pin terminal 31 with the first holding member 33 by insert molding, and cover the pin terminal 31 with the first holding member 33. After that, insert the first holding member 33 inside the second holding member 34 to cover the first holding member 33 with the second holding member 34.

Then, insert the recessed part 36d of the first divided piece 36a of the biasing member 36 into the small diameter part 34c of the second holding member 34 from the positive side of the z-axis, and insert the insert 36e of the first divided piece 36a into the insertion part 34f of the second holding member 34. Further, engage the projecting part 36f of the first divided piece 36a with the recessed part 34g of the second holding member 34 and thereby fix the first divided piece 36a to the second holding member 34.

Likewise, insert the recessed part 36d of the second divided piece 36b of the biasing member 36 into the small diameter part 34c of the second holding member 34 from the negative side of the z-axis, and insert the insert 36e of the second divided piece 36b into the insertion part 34f of the second holding member 34. Further, engage the projecting part 36f of the second divided piece 36b with the recessed part 34g of the second holding member 34 and thereby fix the second divided piece 36b to the second holding member 34.

As the biasing member 36 has a divided structure in this manner, even after the wire 43 is inserted inside the first shell 38 and the second shell 39 and the pin terminal 31 is insert-molded into the first holding member 33, the first holding member 33 into which the pin terminal 31 is insert-molded can be easily surrounded by the biasing member 36. The first divided piece 36a and the second divided piece 36b are thereby fixed to the second holding member 34 in the state of surrounding the extension part 33c of the first holding member 33.

After that, draw the wire 43 to the positive side of the y-axis. In addition, draw the pin terminal 31, the first holding member 33, the second holding member 34, and the biasing member 36 inside the first penetration part 35a and the second penetration part 35b of the insulator 35 and screw the external thread 34a of the second holding member 34 into the internal thread 35e of the insulator 35 to bring an end of the biasing member 36 on the positive side of the y-axis into contact with the first step part 35f of the insulator 35.

It is preferred to insert a tool into the insertion part 34b of the second holding member 34 to screw the second holding member 34. This allows easily screwing and fixing the second holding member 34 into the first penetration part 35a of the insulator 35.

In this step, the flange part 33b of the first holding member 33 is placed between the biasing member 36 and the second holding member 34. The biasing member 36 is placed between the second holding member 34 and the first step part 35f of the insulator 35. Further, the pin terminal 31 is fixed to the first holding member. Thus, the pin terminal 31 and the first holding member 33 are fixed to the insulator 35.

In this state, the resin member 37 is introduced into the first penetration part 35a of the insulator 35. Since the pin terminal 31 and the first holding member 33 are fixed to the insulator 35 as described above, there is no need to fix the wire 43 by a jig or the like to prevent the pin terminal 31 and the first holding member 33 from moving in the y-axis direction until the resin member 37 is cured, for example, which allows the pin terminal 31 to be disposed easily and accurately.

Then, draw the insulator 35 to which the wire 43, the pin terminal 31 and the like are fixed to the positive side of the y-axis. At the same time, insert a part of the insulator 35 on the positive side of the y-axis inside the first shell 38 and screw the external thread 41a of the third shell 41 into the internal thread 39c of the second shell 39 to insert a part of the third shell 41 on the positive side of the y-axis between the insulator 35 and the second shell 39.

After that, put the insulating member 40 in the x-axis direction between the interposing members 45 placed across the flat parts 39d disposed on both sides of the wire 43 in the z-axis direction in the second shell 39 and fix the wire 43 to the second shell 39, thereby assembling the pin connector 23.

The flow of connecting the socket connector 22 and the pin connector 23 of the connector unit 21 according to this embodiment is described hereinafter. As shown in FIGS. 14 and 15, for example, connect a part of the insulator 27 on the inner side of the radial direction relative to the insertion part 27c of the insulator 27 in the socket connector 22 into the second penetration part 35b of the insulator 35 in the pin connector 23, and further insert a part of the insulator 27 on the positive side of the y-axis in the socket connector 22 into the first insertion part 35c of the insulator 35 in the pin connector 23.

At the same time, as shown in FIGS. 14 and 15, insert a part of the insulator 35 on the negative side of the y-axis in the pin connector 23 into the insertion part 27c of the insulator 27 in the socket connector 22, and further insert a part of the third shell 41 on the negative side of the y-axis into the insertion part 29d of the shell 29 in the socket connector 22.

In this step, insert the projecting part 41b of the third shell 41 in the pin connector 23 into the recessed part 29e of the shell 29 in the socket connector 22. This prevents relative displacement of the socket connector 22 and the pin connector 23 around the y-axis.

Then, as shown in FIGS. 14 and 15, insert a part of the pin terminal 31 on the negative side of the y-axis in the pin connector 23 and the contact 32 into the first insertion part 24e of the socket terminal 24 in the socket connector 22.

Further, as shown in FIGS. 14 and 15, insert an end of the first holding member 33 on the negative side of the y-axis in the pin connector 23 into the insertion part 25b of the first holding member 25 in the socket connector 22 and thereby bring the end face 33d of the first holding member 33 on the negative side of the y-axis in the pin connector 23 into contact with the end face 24g of the socket terminal 24 on the positive side of the y-axis in the socket connector 22.

At the same time, as shown in FIGS. 14 and 15, bring the end face 33d of the first holding member 33 on the negative side of the y-axis in the pin connector 23 into contact with the end face 25c of the insertion part 25b of the first holding member 25 on the negative side of the y-axis in the socket connector 22. Further, bring the outer peripheral surface of the tubular part 33a of the first holding member 33 in the pin connector 23 into contact with the peripheral surface of the insertion part 25b of the first holding member 25 in the socket connector 22.

Since the first holding member 33 of the pin connector 23 is made of an elastic material, the end face 33d of the first holding member 33 on the negative side of the y-axis in the pin connector 23 comes into intimate contact with the end face 24g of the socket terminal 24 on the positive side of the y-axis in the socket connector 22, thereby achieving an airtight structure.

At the same time, the end face 33d of the first holding member 33 on the negative side of the y-axis in the pin connector 23 comes into intimate contact with the end face 25c of the insertion part 25b of the first holding member 25 on the negative side of the y-axis in the socket connector 22, thereby achieving an airtight structure. Further, the outer peripheral surface of the tubular part 33a of the first holding member 33 in the pin connector 23 comes into intimate contact with the peripheral surface of the insertion part 25b of the first holding member 25 in the socket connector 22, thereby achieving an airtight structure.

Further, the outer peripheral surface of the socket terminal 24 in the socket connector 22 is covered in an airtight manner with the first holding member 25 to achieve an airtight structure, and the outer peripheral surface of the pin terminal 31 in the pin connector 23 is covered in an airtight manner with the first holding member 33 to achieve an airtight structure.

Then, rotate the fourth shell 42 of the pin connector 23 and screw the internal thread 42a of the fourth shell 42 into the external thread 29c of the shell 29 in the socket connector 22, thereby connecting the socket connector 2 and the pin connector 3.

At this time, the biasing member 36 exerts a force on the first holding member 33 toward the negative side of the y-axis while exerting a reaction force on the first step part 35f of the insulator 35, and thereby brings the end face 33d of the first holding member 33 on the negative side of the y-axis in the pin connector 23 into contact with the end face 24g of the socket terminal 24 on the positive side of the y-axis in the socket connector 22 and further brings the end face 33d of the first holding member 33 on the negative side of the y-axis in the pin connector 23 into contact with the end face 25c of the insertion part 25b of the first holding member 25 on the negative side of the y-axis in the socket connector 22.

In this manner, with the above-described airtight structure, the connector unit 21 according to this embodiment is also capable of controlling partial discharge in the connection state of the socket connector 22 and the pin connector 23. The connector unit 21 according to this embodiment uses an elastic member as the first holding member 33 that holds the pin terminal 31 of the pin connector 23.

This eliminates the need to prepare a seal packing in addition to the first holding member 25 of the socket connector 22 and the first holding member 33 of the pin connector 23 in order to achieve an airtight structure around the socket terminal 24 and the pin terminal 31 in the connection state of the socket connector 22 and the pin connector 23, which allows achieving an airtight structure around the socket terminal 24 and the pin terminal 31 with a smaller number of parts compared with the connector unit 100 according to Patent Literature 1. This also allows the connector unit 21 according to this embodiment to be reduced in size and manufactured at lower cost and with simpler processes compared with the connector unit 100 according to Patent Literature 1.

Particularly, since the biasing member 36 is configured as a divided structure in the connector unit 21 according to this embodiment, it allows the first holding member 33 into which the pin terminal 31 is insert-molded to be easily surrounded by the biasing member 36.

Further, in the case where the first holding member 33 to which the pin terminal 31 is fixed is put between the biasing member 36 and the second holding member 34 and fixed to the insulator 35 in the connector unit 21 according to this embodiment, there is no need to fix the wire 43 with a jig or the like to prevent the pin terminal 31 and the first holding member 33 from moving in the y-axis direction until the resin member 37 is cured, for example, which allows the pin terminal 31 to be disposed easily and accurately.

Note that the structures of the socket connector 22 and the pin connector 23 according to this embodiment are by way of illustration only, and they may have any structure as long as the first holding member 33 of the pin connector 23 is an elastic member, and in the state where the socket connector 22 and the pin connector 23 are connected, the end face 33d of the first holding member 33 on the negative side of the y-axis in the pin connector 23 comes into contact with the end face 24g of the socket terminal 24 on the positive side of the y-axis in the socket connector 22 and further the end face 33d of the first holding member 33 on the negative side of the y-axis in the pin connector 23 comes into contact with the end face 25c of the insertion part 25b of the first holding member 25 on the negative side of the y-axis in the socket connector 22, and the biasing member 36 has a divided structure.

Further, the flow of assembling the socket connector 22 and the pin connector 23 according to this embodiment is by way of illustration only, and the order of assembly is not particularly limited.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connector unit comprising:
a socket connector including a socket terminal and a socket-side holding member configured to cover an outer peripheral surface of the socket terminal in an airtight manner; and
a pin connector including a pin terminal to be connected to the socket terminal and a pin-side holding member configured to cover an outer peripheral surface of the pin terminal in an airtight manner, wherein
the socket-side holding member includes a recessed part formed to surround an end face of the socket terminal on a connection side with the pin connector and where an end of the pin-side holding member on a connection side with the socket connector is to be inserted in a state where the socket connector and the pin connector are connected,
the pin-side holding member is made of an elastic material, and
inside the recessed part of the socket-side holding member in the state where the socket connector and the pin connector are connected, the end face of the socket terminal on the connection side with the pin connector comes into contact with the pin-side holding member, and the end of the pin-side holding member on the connection side with the socket connector comes into contact with a bottom face of the recessed part of the socket-side holding member.

2. The connector unit according to claim 1, wherein in the state where the socket connector and the pin connector are connected, a peripheral surface of the end of the pin-side holding member on the connection side with the socket connector comes into contact with a peripheral surface of the recessed part of the socket-side holding member.

3. The connector unit according to claim 1, wherein inside the recessed part of the socket-side holding member, the end face of the socket terminal on the connection side with the pin connector and the bottom face of the recessed part of the socket-side holding member are flush with each other.

4. The connector unit according to claim 1, wherein the pin connector includes a biasing member configured to exert a force on the pin-side holding member toward the connection side with the socket connector when the socket connector and the pin connector are connected and the pin-side holding member is pushed to a side opposite to the connection side with the socket connector.

5. The connector unit according to claim 4, wherein the pin-side holding member includes a flange part to be pushed by the biasing member.

6. The connector unit according to claim 1, wherein the socket-side holding member is formed integrally with the socket terminal by insert molding.

7. The connector unit according to claim 6, wherein
the socket terminal includes a flange part, and
the socket-side holding member is formed to cover the flange part of the socket terminal.

8. The connector unit according to claim 1, wherein the pin-side holding member is formed integrally with the pin terminal by insert molding.

9. A connector unit comprising:
a socket connector including a socket terminal and a socket-side holding member configured to cover an outer peripheral surface of the socket terminal in an airtight manner; and
a pin connector including a pin terminal to be connected to the socket terminal, a first pin-side holding member configured to cover an outer peripheral surface of the pin terminal in an airtight manner, and a biasing member configured to exert a force on the first pin-side holding member toward a connection side with the socket connector when the first pin-side holding member is pushed to a side opposite to the connection side with the socket connector, wherein
the socket-side holding member includes a recessed part formed to surround an end face of the socket terminal on a connection side with the pin connector and where an end of the first pin-side holding member on the connection side with the socket connector is to be inserted in a state where the socket connector and the pin connector are connected,
the first pin-side holding member is made of an elastic material,
inside the recessed part of the socket-side holding member in the state where the socket connector and the pin connector are connected, the end face of the socket terminal on the connection side with the pin connector comes into contact with the first pin-side holding member, and the end of the first pin-side holding member on the connection side with the socket connector comes into contact with a bottom face of the recessed part of the socket-side holding member,
the first pin-side holding member includes a flange part to be pushed by the biasing member and an extension part extending to the side opposite to the connection side with the socket connector relative to the flange part, and
the biasing member includes a plurality of divided pieces and is disposed to surround the extension part of the first pin-side holding member.

10. The connector unit according to claim 9, wherein the pin connector includes:
a second pin-side holding member configured to hold the first pin-side holding member;
an insulator having a penetration part where the second pin-side holding member holding the first pin-side holding member is to be inserted; and
a resin member to be introduced into a part of the penetration part of the insulator on the side opposite to the connection side with the socket connector relative to the second pin-side holding member, wherein
the biasing member is disposed between the second pin-side holding member and a step part formed in the penetration part of the insulator.

11. The connector unit according to claim 10, wherein
a divided piece of the biasing member includes an engaging part,
the second pin-side holding member includes an engaged part to be engaged with the engaging part of the biasing member, and
in a state where the engaging part of the divided piece of the biasing member engages with the engaged part of the second pin-side holding member, the divided piece of the biasing member is fixed to surround the extension part of the first pin-side holding member.

12. The connector unit according to claim 9, wherein in the state where the socket connector and the pin connector are connected, a peripheral surface of the end of the first pin-side holding member on the connection side with the socket connector comes into contact with a peripheral surface of the recessed part of the socket-side holding member.

13. The connector unit according to claim 9, wherein inside the recessed part of the socket-side holding member, the end face of the socket terminal on the connection side with the pin connector and the bottom face of the recessed part of the socket-side holding member are flush with each other.

14. The connector unit according to claim 9, wherein the socket-side holding member is formed integrally with the socket terminal by insert molding.

15. The connector unit according to claim 14, wherein
the socket terminal includes a flange part, and
the socket-side holding member is formed to cover the flange part of the socket terminal.

16. The connector unit according to claim 9, wherein the first pin-side holding member is formed integrally with the pin terminal by insert molding.
